(19) United States
(12) Patent Application Publication
(10) Pub. No.: US 2012/0013651 A1
(43) Pub. Date: Jan. 19, 2012

(54) Autostereoscopic Display Device

(76) Inventors: David John Trayner, London (GB); Edwina Margaret Orr, London (GB)

(21) Appl. No.: 13/145,511

(22) PCT Filed: Jan. 22, 2010
(86) PCT No.: PCT/GB10/00106

§ 371 Date: Oct. 5, 2011

(30) Foreign Application Priority Data
Jan. 22, 2009 (GB) 0901084.4

(51) Int. Cl. G09G 3/36; G09G 5/10

(52) U.S. Cl. 345/690; 345/102

(57) ABSTRACT

Multi-user stereoscopic display system, providing different stereoscopic or 2D images to different viewers, by combining spatial and temporal multiplexing techniques for providing stereo effect and multi-viewer effect: one group of embodiments defines multi-user autostereoscopic display system comprising controllable light source array/s, holographic optical element/s (HOE) and a transmissive display panel such as an LCD, each light source being associated to a viewing zone; an other group of embodiments defines multi-user stereoscopic display system using glasses with polarizers and shutters.

This invention relates to the field of electronic displays and in particular though not exclusively to autostereoscopic displays, where a 3D stereoscopic image can be enjoyed without the need for special eye-wear.

A number of different autostereoscopic display technologies exist. At their most basic the viewer has to be located in a “sweet spot” in order to perceive the 3D effect. If the viewer moves away from this position the 3D effect is lost or severely compromised.

Some technologies allow a number of people to see the same stereoscopic 3D image, but again it is necessary for each viewer to find the correct viewing position.

Such methods in practice do not allow the perception of parallax (the ability look around an image) as the viewer is fixed in one position.

An alternative approach is to provide a set of perspective views—not just a stereo pair but maybe 9 views on the same subject (these are usually called “multi-view” displays—not to be confused with “multiple-viewer” displays). These are arranged to provide a number of viewing positions arrayed next to each other. Frequently also, the displays generate “side lobes”—repeats of the same array on either side of the main array. This is a way of allowing more than one viewer to perceive a 3D image with an element of horizontal (x-axis) parallax without having to search for a sweet spot. Note that there is no vertical (y-axis) parallax and distance (z-axis) parallax will be poor unless the number of views is large and their spacing small.

This approach has been shown to work effectively where the priority is impact rather than image fidelity, quality and resolution. The main difficulty is an inescapable trade-off between 3D resolution and 2D resolution. In order to improve the 3D resolution many closely-spaced views are needed to reduce stereo quantisation errors. But as every view is simultaneously and separately displayed the base (2D) resolution of the display will be divided by the number of views and the picture quality severely compromised as a result.

The number of different views is therefore a critical factor in these technologies, current multi-view autostereoscopic displays use around 9 views. Human factors research and experience in hard copy composite holographic stereograms shows that in order to display smooth, high quality and a convincingly deep pictures the 3D perspective views should be separated by 0.4° or less, which means that the number of separate views should be increased by a factor of at least ten over the existing norm and the base resolution would have to be shared between about one hundred different component images before even a basic level of image fidelity could be expected. Not only is this impractical, it is also inefficient—if there are, say, 4 viewers, then there are only eight eyes looking a the display, so only eight images are needed to provide each viewer with a 3D picture. So the multi-view approach has intractable problems if high quality low fatigue 3D picture have to be displayed and is also makes inefficient use of the available resolution.

Consequently such displays always present performance limitations which, while they may be suitable for advertising and eye-catching effects, renders them practically useless for intense use such as professional work, computer gaming or watching 3D films.

A different approach is to have the display track the viewer. In such a system the display is provided with a device that detects the viewer's position and allows the display to adjust itself to direct the left view to the viewer's left eye and the right view to his or her right eye. This allows the display to move the stereo window to ensure that the viewer does not lose a 3D view and also allows the perspective views to be updated to match the viewer's position in front of the display. Importantly, the 2D resolution is independent of the 3D resolution allowing very high quality full parallax 3D without greatly compromising the 2D resolution. This provides parallax in all three (x,y,z) directions and provides a remarkably strong 3D image for one viewer. An example is described in EP-A-0764281.

But a fundamental limitation with the approach described in EP-A-0764281 is that while multiple mobile viewers can be catered for, only one can enjoy naturalistic parallax at a time. This is because each viewer sees the same stereoscopic image, so if the perspective updates according to the position of one viewer then all the viewers will perceive the perspective changing according to that person's movements, which is likely to be a disturbing effect.

### SUMMARY OF THE INVENTION

In accordance with a first aspect of the present invention, an autostereoscopic display device is provided, capable of displaying different images to multiple viewers, said display device comprising;
a pixel array, wherein a first set of pixels within the pixel array cooperates to display a first image and a second, different set of pixels within the pixel array cooperate to display a second image;
a light source array comprising a plurality of light sources, each adapted to individually illuminate the pixel array in use;
a holographic optical element (HOE), spatially multiplexed to cooperate with said pixel array such that light from a first light source from within the light source array impinging on the first set of pixels is diffracted by the HOE towards a first position to form a first real image for the left eye of a first viewer and light from the first light source impinging on the second, different set of pixels is diffracted towards a second position to form a second real image for the right eye of said first viewer, whereby the first and second real images together form a first viewing zone;
wherein the HOE diffracts light from different light sources within the light source array to form corresponding spatially displaced viewing zones;
and further comprising control apparatus adapted to cause the first and second sets of pixels to display successively selected pairs of first and second images and to cause the light sources within the light source array to be successively activated in synchronisation with the successively selected image pairs such that light from only one light source within the light source array is incident on the HOE at any one time thereby providing multiple viewing zones for multiple viewers successively and in spatially displaced positions.

Such a configuration allows multiple viewers viewing the same screen to enjoy their own individual image without the need for special eyewear, thus providing increased viewer comfort and flexibility. In one example embodiment, the successively selected pairs of images may be different pairs of images so that the viewers see different images, or they may be the same pairs of images such that the viewers see the same image. “Spatially displaced” means that the viewing zones are not formed in precisely the same position as one another. In many cases it will be preferred that the viewing zones are spaced from one another to allow for spacing between the viewers. However, the viewing zones can overlap one another, as discussed below.

A particular advantage of this aspect is that the amount of spatial resolution lost upon the introduction of each viewer is much less than that of the prior art multi-view systems.

In a preferred implementation of this embodiment, the first and second images are the left and right images of a stereoscopic pair respectively, thus allowing the viewer to see a 3D stereoscopic image. However, the first and second images may be chosen to be the same image, so that the multiple viewers are able to see multiple 2D images. The first and second images are preferably arranged to abut one another when forming the viewing zone.

Preferably, the display device is equipped with a viewer detection means to detect the location of one or more viewers, thus allowing viewing zones to be formed in relation to the position of a viewer by activating the relevant light sources. This means that a viewer is not confined to a single location in order to view a stereoscopic 3D image. Since the viewing zones can overlap in spatial position though this will only occur when the overlapping viewing zones are to be formed at different times sequentially, this allows an image to be displayed to a moving viewer, smoothly, without jumps or breaks in the viewing zones.

Further, since each viewer is able to see his own individual image, each viewer is able to perceive natural parallax with full x, y and z directionality without distortion if the pixels are refreshed accordingly to show the correct perspective images in relation to the position of the viewer.

In a second aspect of the present invention, an autostereoscopic display device capable of displaying different images to multiple viewers is provided, said display device comprising;
a pixel array, wherein
a first set of pixels within the pixel array cooperates to display a first image,
a second, different set of pixels within the pixel array cooperate to display a second image,
a third, different set of pixels within the pixel array cooperates to display a third image,
a fourth, different set of pixels within the pixel array cooperate to display a fourth image;
a plurality of light source arrays, each light source array comprising a plurality of light sources, each of the light sources being adapted to individually illuminate the pixel array;
a holographic optical element (HOE), spatially multiplexed to cooperate with said pixel array such that light from a first light source from within a first light source array impinging on the first set of pixels is diffracted by the HOE towards a first position to form a first real image for the left eye of a first viewer, and light impinging on the second, different set of pixels is diffracted towards a second position to form a second real image for the right eye of said first viewer, whereby the first and second real images together form a first viewing zone;
and whereby light from a first light source from within a second light source array impinging on the third set of pixels is diffracted by the HOE towards a third position to form a third real image for the left eye of a second viewer, and light impinging on the fourth, different set of pixels is diffracted towards a fourth position to form a fourth real image for the right eye of said second viewer, whereby the third and fourth real images together form a second viewing zone;
wherein the HOE or a filter element is adapted to prevent light from the first light source array from being diffracted towards the second viewing zone and likewise to prevent light from the second light source array from being diffracted towards the first viewing zone;
and further wherein the HOE diffracts light from different light sources within each light source array to form the respective viewing zones in corresponding spatially displaced positions.

Preferably, the display device is equipped with a viewer detection means to detect the location of the first and second viewers, thus allowing first and second viewing zones to be formed in relation to the position of the first and second viewers. In one example embodiment, the first viewer and second viewers are different viewers, and in another embodiment the first and second viewers are the same viewer.

Each light source within a light source array provides a spatially displaced viewing zone. Thus, the activation of the light sources to provide spatially displaced viewing zones can be utilised to track a moving viewer, hence improving over the viewing “sweetspots” of prior art systems.

Therefore this aspect provides the advantage, similarly to the first aspect, of being able to provide one or more moving viewers with their own individual image with natural parallax with full x, y and z directionality if the pixels are refreshed accordingly to show the correct perspective images in relation to the position of the viewer; and without the requirement for special eyewear. The spatial resolution is also much improved over prior art multi-view systems.

In a third aspect of the invention, an autostereoscopic display capable of displaying different images to multiple viewers is provided, said display comprising;
first and second light source arrays, each light source array comprising a plurality of pairs of light sources;
a pixel array having a first set of pixels corresponding to the first light source array adapted to display a first image for the left eye of a first viewer and a second image for the right eye of a first viewer, alternately, and a second set of pixels adapted to display a third image for the left eye of a second viewer and a fourth image for the right eye of a second viewer, alternately;
wherein each of the light sources is adapted to individually illuminate the pixel array;
a HOE, spatially multiplexed to cooperate with said pixel array such that light from one light source of a pair of light sources within the first light source array impinging on the corresponding first set of pixels is diffracted by the HOE towards a first position to form a first real image for the left eye of a first viewer, and light from the other light source of the pair impinging on the first set of pixels is diffracted by the HOE towards a second position to form a second real image for the right eye of a first viewer whereby the said first and second real images together form a first viewing zone;
and wherein light from one light source of a pair of light sources within the second light source array impinging on the corresponding second set of pixels is diffracted by the HOE towards a third position to form a third real image for the left eye of a second viewer, and light from the other light source of the pair impinging on the set of pixels is diffracted by the HOE towards a fourth position to form a fourth real image for the right eye of a second viewer whereby the said third and fourth real images together form a second viewing zone;
and wherein the HOE diffracts light from different pairs of light sources within each light source array to form the respective viewing zones in corresponding spatially displaced positions;
control apparatus adapted to cause each set of pixels within said pixel array to display successive left-eye and right-eye images in synchronisation with activating the corresponding light sources within each pair of light sources;
and wherein the HOE or a filter element is adapted to prevent light from the first light source array from being diffracted towards the second viewing zone and likewise to prevent light from the second light source array from being diffracted towards the first viewing zone.

By spatially filtering the light from the first and second light source arrays in this way, the device forms the first viewing zone from light from the first light source array only, and similarly the second viewing zone from light from the second light source array only. As such, the multiple viewing zones can be controlled independently of one another. This spatial filtering may be performed by the HOE itself or by an additional filter element.

Here, in one example embodiment, the first viewer and second viewers are different viewers, and in another embodiment the first and second viewers are the same viewer (moving from one position to another).

Preferably, the display device of this embodiment is equipped with a viewer detection means to detect the location of one or more viewers, thus allowing viewing zones to be formed in relation to the position of a viewer by activating the relevant light source. Again, similarly, to the first two embodiments, this embodiment can advantageously provide multiple moving viewers with their own individual image with natural parallax with full x, y and z directionality if the pixels are refreshed accordingly to show the correct perspective images in relation to the position of the viewer; without the requirement for special eyewear. The spatial resolution is also much improved over prior art multi-view systems.

Advantageously, an individual light source within each pair of light sources can comprise a sub array of light emitters. This allows cheaper light sources to be utilised.

Preferably, for both the second and third embodiments described above, the first and second images are the left and right images of a stereoscopic pair, and abut one another when forming the viewing zone. Similarly the third and fourth images make up a second, different, stereoscopic pair. However, the first image may be the same as the third image, likewise with the second and fourth images, such that different viewers see the same stereoscopic image. Further, the first and second images may be the same so that the first viewer sees a 2D image, and likewise for the third and fourth images. These possibilities can be advantageously implemented in any combination to give multiple viewers their own tailored viewing experience.

Preferably, light from different light source arrays is incident on the HOE and pixel array so as to form concurrent, spatially displaced viewing zones. In practice this can be achieved either by illuminating the HOE and pixel array simultaneously with light from both light source arrays, or by alternating pulsed illumination from each array very rapidly. This allows multiple viewers to concurrently view their own image, since incident light from other light source arrays will be filtered out by the combination of the HOE makeup and the positioning of the light source arrays; or by using a polarising filter in combination with the HOE and pixel array to selectively block oppositely polarised light from differing light sources.

It is envisaged that the device will usually be configured such that light from the different light source arrays will form viewing zones which are spatially separate from one another so as to increase the number of individual viewers, or to provide more viewing zones for an individual viewer. However, it is possible for light from light sources in differing light source arrays to form viewing zones at the same spatial position. This could be used for calibration purposes, as an example.

In a fourth aspect of the present invention, a display capable of displaying different images to multiple viewers is provided, said display comprising;
first and second light source arrays, each light source array comprising a plurality of light sources;
a pixel array having a first set of pixels corresponding to the first light source array adapted to display a first image, and a second set of pixels adapted to display a second image;
wherein each of the light sources is adapted to individually illuminate the pixel array;
a HOE, spatially multiplexed to cooperate with said pixel array such that light from one light source within the first light source array impinging on the corresponding first set of pixels is diffracted by the HOE towards a first position to form a first real image for a first viewer, said first real image forming a first viewing zone;

and wherein light from one light source within the second light source array impinging on the corresponding second set of pixels is diffracted by the HOE towards a second position to form a second real image for a second viewer, said second image forming a second viewing zone;
and wherein the HOE diffracts light from different light sources within each light source array to form the respective viewing zones in corresponding spatially displaced positions;

and wherein the HOE or a filter element is adapted to prevent light from the first light source array from being diffracted towards the second viewing zone and likewise to prevent light from the second light source array from being diffracted towards the first viewing zone.

In one example embodiment, the first viewer and second viewers are different viewers, and in another embodiment the first and second viewers are the same viewer.

In a preferred implementation of the abovementioned fourth embodiment, a viewer detection means is provided to detect the location of one or more viewers, thus allowing viewing zones to be formed in relation to the position of a viewer. This provides the advantage of allowing a viewer to move around and still see his individual image on the screen.

Preferably, the first set of pixels in the pixel array displays a third image alternately with the first image, and the second set of pixels in the pixel array displays a fourth image alternately with the second image, and the embodiment further comprises control apparatus adapted to cause the first and second sets of pixels to display successive images and to cause the light sources within each light source array to be successively activated in synchronisation with the successive images such that light from only one light source within each light source array is incident on the HOE at any one time.

This advantageously allows more viewers to see their own individual image on the screen without a reduction in spatial resolution.

In a fifth aspect of the present invention, a multi-view autostereoscopic display comprises
a pixel array providing a plurality of sets of pixels, the first set of pixels being adapted to display a first image and a third image, sequentially, and the second set of pixels being adapted to display a second and fourth image, sequentially;
first and second light sources, each of the light sources being adapted to individually illuminate the pixel array;
a HOE spatially multiplexed to cooperate with said pixel array such that light from the first light source impinging on a first set of pixels is diffracted by the HOE towards a first position to form a first real image for a viewer, and light from the first light source impinging on a second, different set of pixels is directed towards a second position spatially displaced from the first to form a second real image for the viewer, and further wherein the spatial multiplexing of the HOE is adapted such that light from the second light source impinging on the first set of pixels is diffracted by the HOE towards a third position to form a third real image for the viewer, and light from the second light source impinging on the second, different set of pixels is directed towards a fourth position, spatially displaced from the third to form a fourth real image for the viewer, said first and second real images being spatially displaced from the third and fourth real images; and
control apparatus adapted to cause the first set of pixels to sequentially display the first and third images in synchronisation with sequential activation of the first and second light sources, and to cause the second set of pixels to sequentially display the second and fourth images in synchronisation with sequential activation of the first and second light sources.

This embodiment has the advantage of doubling the spatial resolution of a multi-view display by utilising temporal multiplexing. Preferably, each image is a different perspective view of an object, and adjacent real images form a stereo pair to provide a 3D stereoscopic image for the viewer.

In a preferred embodiment, the first and third real images abut one another, and are formed adjacent to or overlapping with the second and fourth real images, wherein said second and fourth real images abut one another.

Alternatively, the first and third real images are interleaved with the second and fourth real images, pair of adjacent images abutting each other.

In all of the embodiments described so far, the real images forming a viewing zone are homogenous and diffuse. Further, the HOE can be either upstream or downstream of the pixel array with respect to the light source arrays(s).

In a sixth embodiment, a stereoscopic display system capable of displaying different images to multiple viewers is provided, said display system comprising;
a display device including a pixel array, spatially multiplexed such that in use a first set of pixels displays a first image for the left eye of a viewer, and a second set of pixels displays a second image for the right eye of a viewer;
polarising apparatus such that the light from the first set of pixels is polarised in one sense, and that the light from the second set of pixels is polarised in a second, opposite, sense;
and viewing apparatus comprising shutters adapted to selectively block light from a viewer's eyes, and complementary polarisers such that the left eye of a viewer is only exposed to the image for the left eye and the right eye is only exposed to the image for the right eye;
and control apparatus adapted to cause the first and second sets of pixels to display successive pairs of first and second images, and to control the shutters in synchronisation with the successive pairs of images such that the viewer is exposed to only selected pairs of images.

In a preferred embodiment, the first image is the left image of a stereoscopic pair and the right image the right image of the same stereoscopic pair, however, they can be the same image.

Preferably, the display device of this embodiment is equipped with a viewer detection means to detect the location of one or more viewers. This advantageously allows multiple viewers to see their own individual 3D stereoscopic image, thus allowing each viewer to perceive parallax with full x, y and z directionality without the images for other viewers becoming distorted if the pixels are refreshed accordingly to show the correct perspective images in relation to the position of the viewer.

In a seventh embodiment, a stereoscopic display system capable of displaying different images to multiple viewers is provided, said display system comprising;
a display device including a pixel array spatially multiplexed such that in use a first set of pixels cooperates to alternately display a first image for the left eye of a first viewer and a second image for the right eye of the first viewer, and a second set of pixels cooperates to alternately display a third image for the left eye of a second viewer and a fourth image for the right eye of the second viewer;
apparatus adapted to polarise the light from the first set of pixels in a first sense, and to polarise the light from the second set of pixels in a second, opposite, sense;
a first viewing apparatus for use by the first viewer adapted to be substantially transparent to light polarised in the first sense and substantially opaque to light polarised in the second sense such that the first viewer only sees light from the first set of pixels;
a second viewing apparatus for use by the second viewer adapted to be substantially transparent to light polarised in the second sense and substantially opaque to light polarised in the first sense such that the second viewer only sees light from the second set of pixels;
wherein the first and second viewing apparatus each comprise shutters adapted to selectively block light from each of a viewer's eyes individually, and
a control apparatus adapted to control the first set of pixels to alternately display first and second images, and the second set to alternately display third and fourth images, and to control the shutters of each viewing apparatus so that only the left eye of the first or second viewer is exposed to the corresponding first or third image and only the right eye of the first or second viewer is exposed to the corresponding second or fourth image.

In a preferred embodiment, the first image is the left image of a stereoscopic pair and the right image the right image of the same stereoscopic pair; however, they can be the same image. Similarly, the first and third images can be the same image and likewise with the second and fourth images such that two viewers see the same image, or they can differ so that two viewers see different images.

The first and second viewers can be different viewers or, alternatively, they can be the same viewer.

Preferably, this display device is equipped with a viewer detection means to detect the location of one or more viewers. This advantageously allows multiple viewers to see their own individual 3D stereoscopic image, thus allowing each viewer to perceive parallax with full x, y and z directionality without the images for other viewers becoming distorted if the pixels are refreshed accordingly to show the correct perspective images in relation to the position of the viewer.

It is understood that the images displayed by the sets of pixels in the abovementioned embodiments can refresh accordingly in order to display a moving image.

In all of the abovementioned embodiments, control apparatus is preferably adapted to refresh the image(s) displayed by the set(s) of pixels at a refresh rate fast enough for a substantially flicker-free image to be seen by the one or more viewers. Preferably the refresh rate for each set of pixels within the pixel array is at least about 60 Hz.

In all of the discussed embodiments, the pixel array is, for example, a LCD array, but can comprise of any suitable array. In addition, light sources are, for example, LEDs, but can be any suitable light source.

In addition, any of the above embodiments can be used to deliver images with different perspective views of an object to all or some of the viewers.

In general, some aims of the present invention are:

1. To display 3D images with full (x,y and z direction) parallax with the best achievable quality.

2. To provide such images to a plurality of viewers with:
No visible quantisation errors
No need to display reduced-disparity hypo-stereoscopic images to mask poor 3D resolution.
No perspective distortion (which means each viewer needs to see a different stereoscopic image)

The above-described devices can be used to achieve some or all of these aims, when implemented to display appropriate images. In general, the described devices may:
Multiplexing images according to a hierarchy of methods in order to separate the stereo views.
Displaying the multiplexed image using a LCD or similar display screen equipped with an illumination system that incorporates at least one multiplexed Holographic Optical Element (HOE) and an appropriate illumination system.
Controlling the illumination system so as direct the correct multiplexed stereo pair to each viewer.

Examples of display devices in accordance with the invention will now be described and contrasted with known display devices with reference to the accompanying drawings, in which:

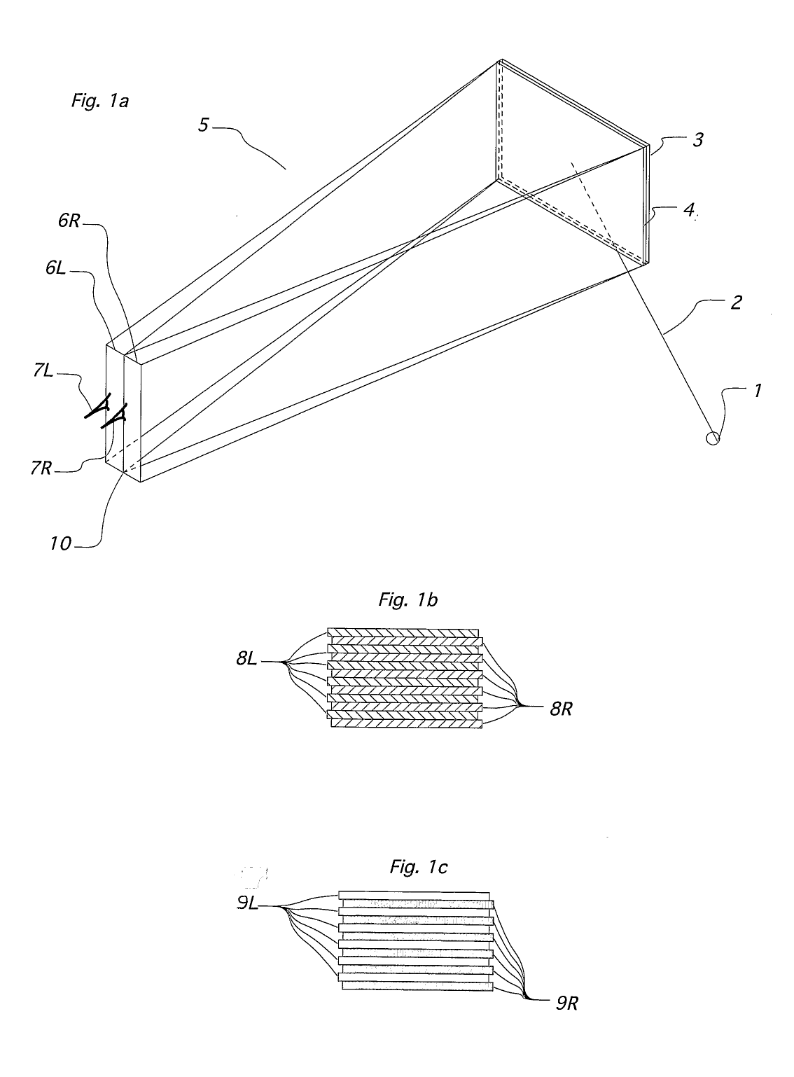

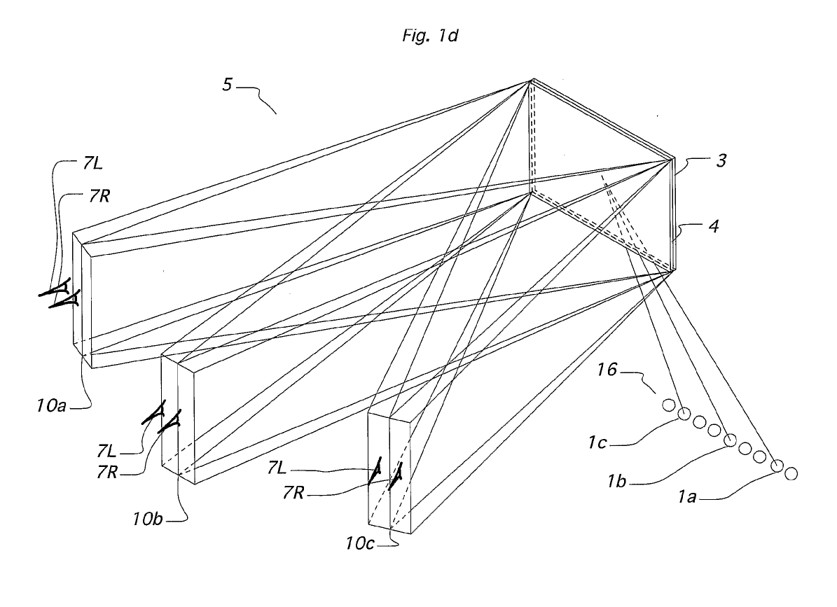

FIG. 1—Autostereoscopic display (ASD) using a spatially multiplexed HOE according to EP-A-0764281.

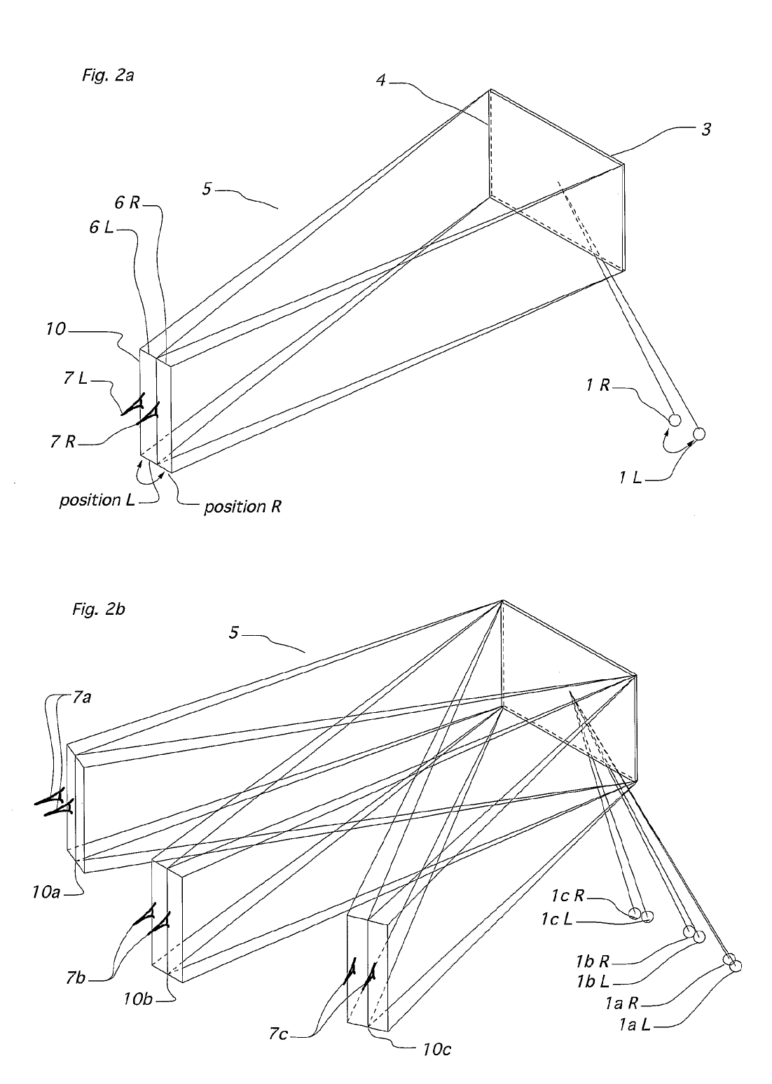

FIG. 2—Temporally multiplexed ASD according to U.S. Pat. No. 5,600,454.

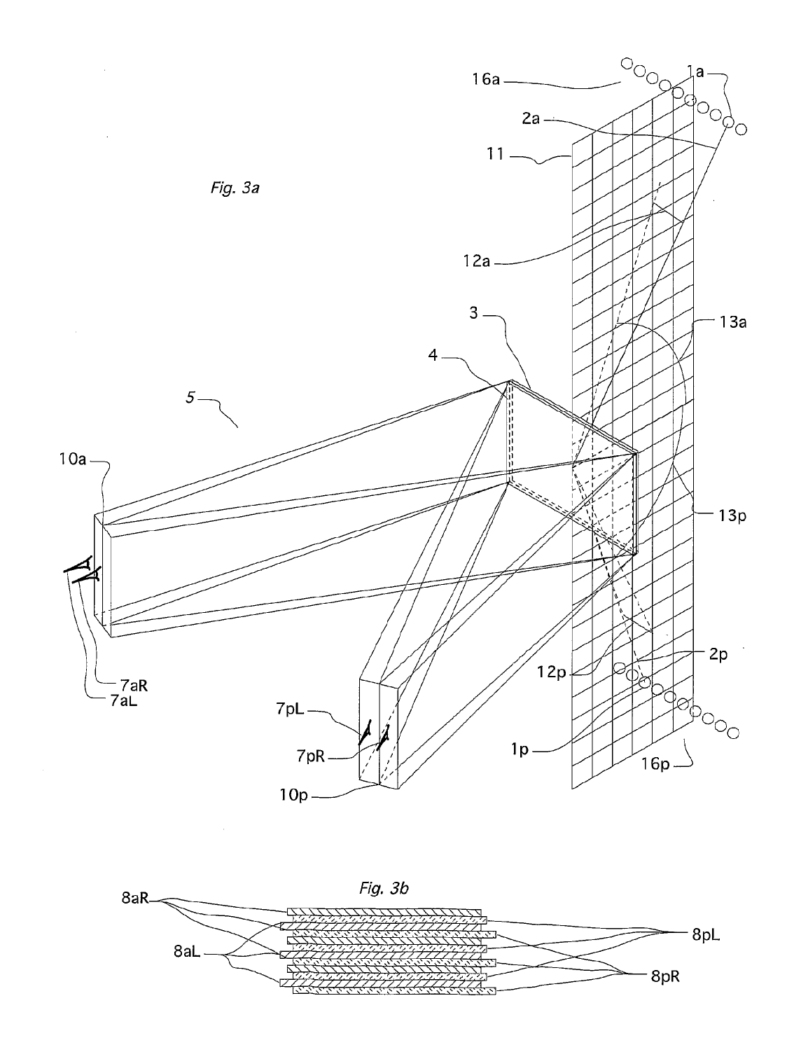

FIG. 3—Hybrid angular and spatial multiplexing.

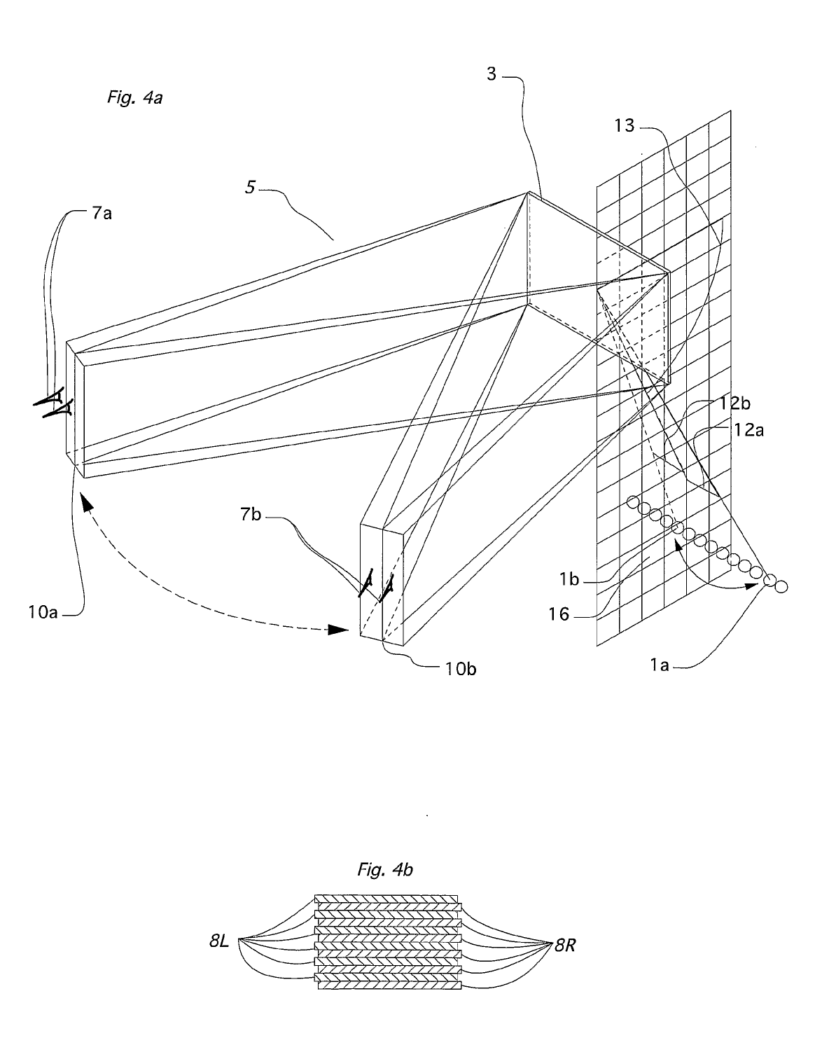

FIG. 4—Hybrid spatial and temporal multiplexing.

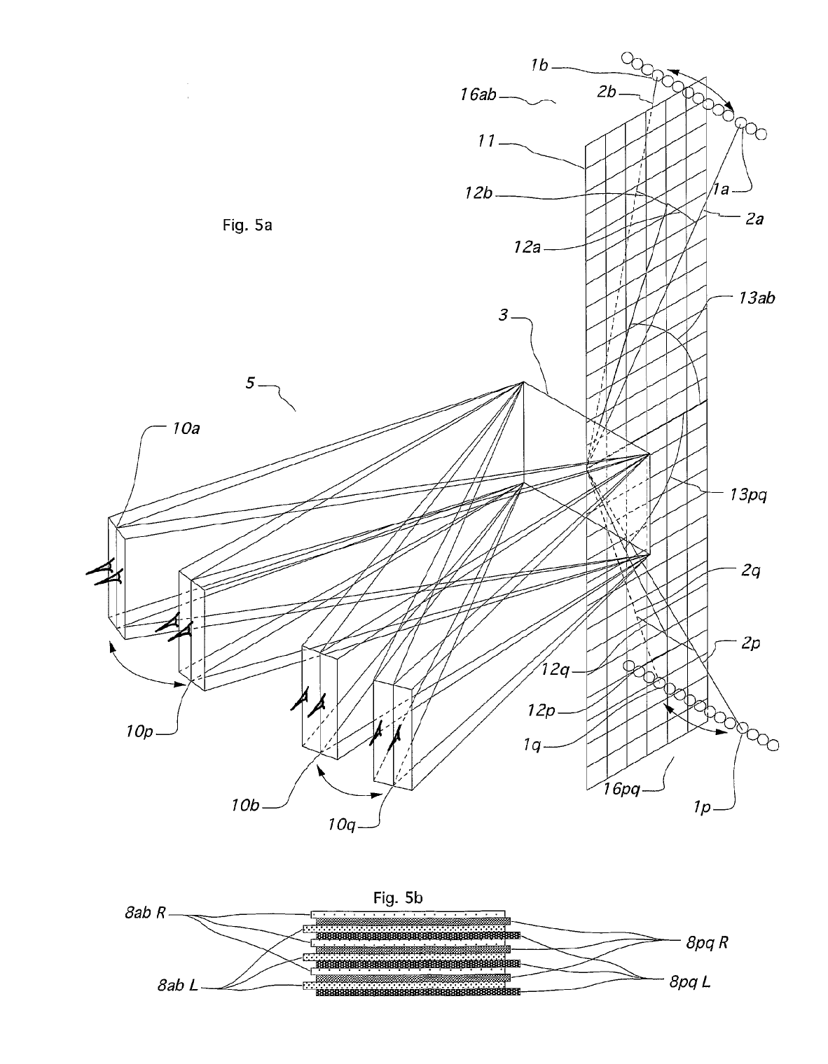

FIG. 5—Hybrid spatial, angular and temporal multiplexing.

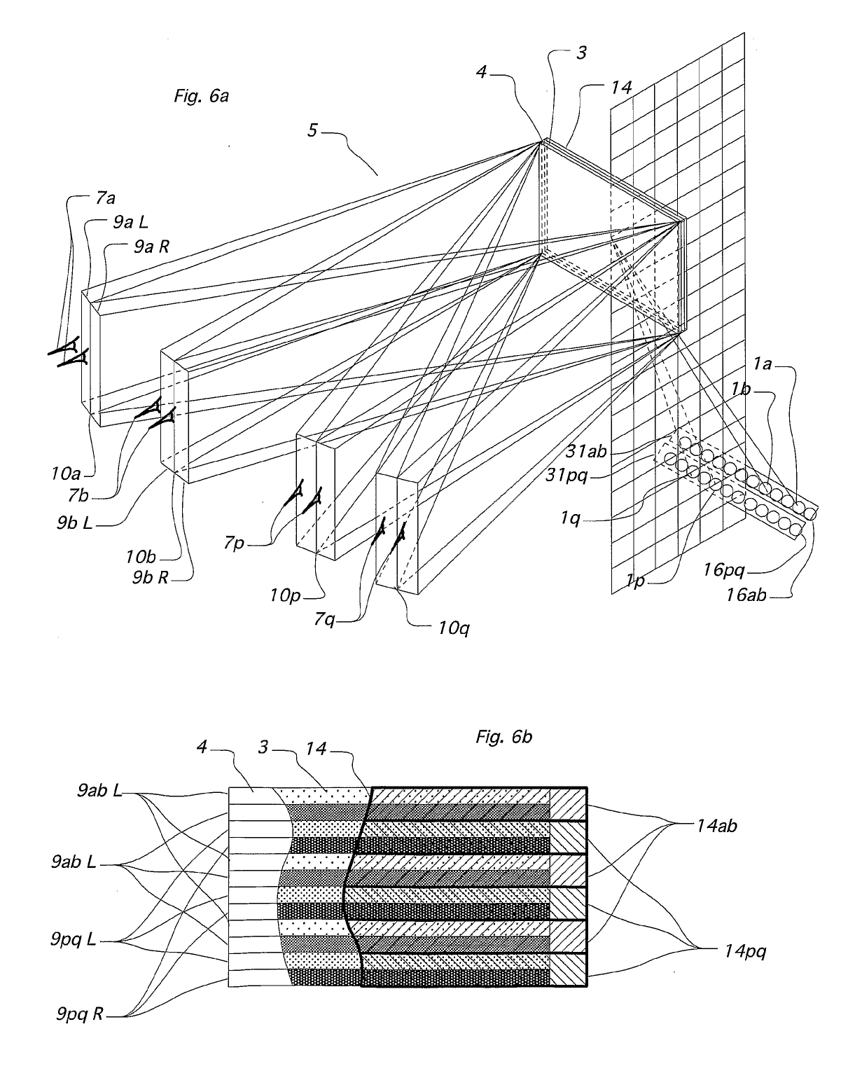

FIG. 6—Hybrid spatial, temporal and polarisation-state multiplexing.

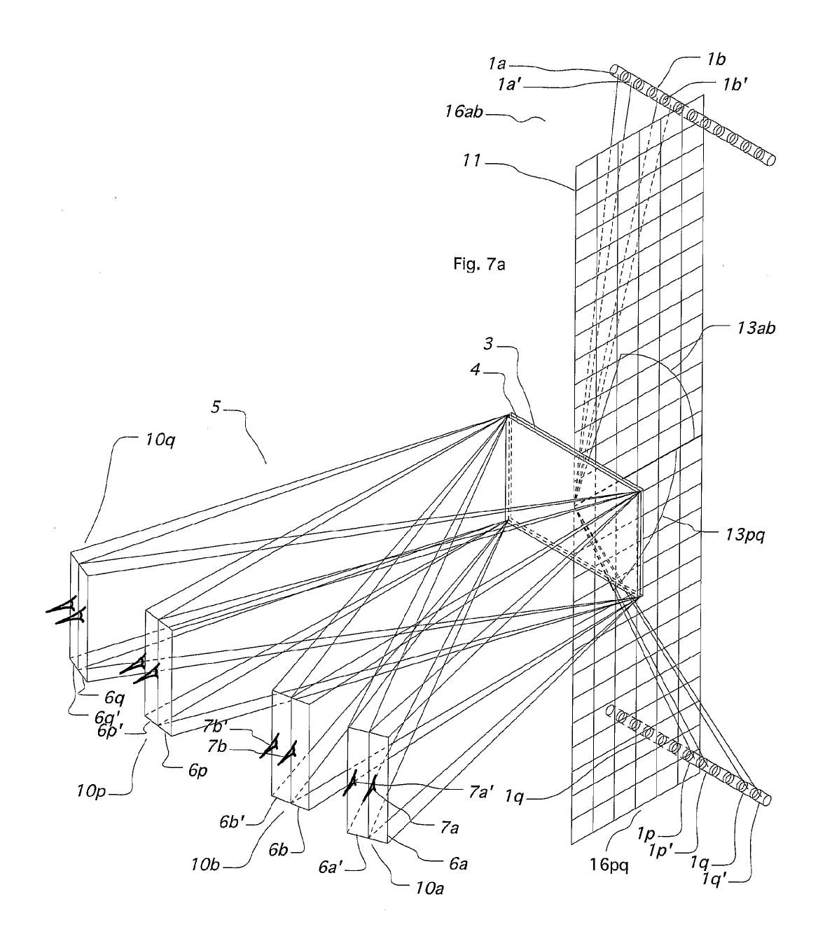

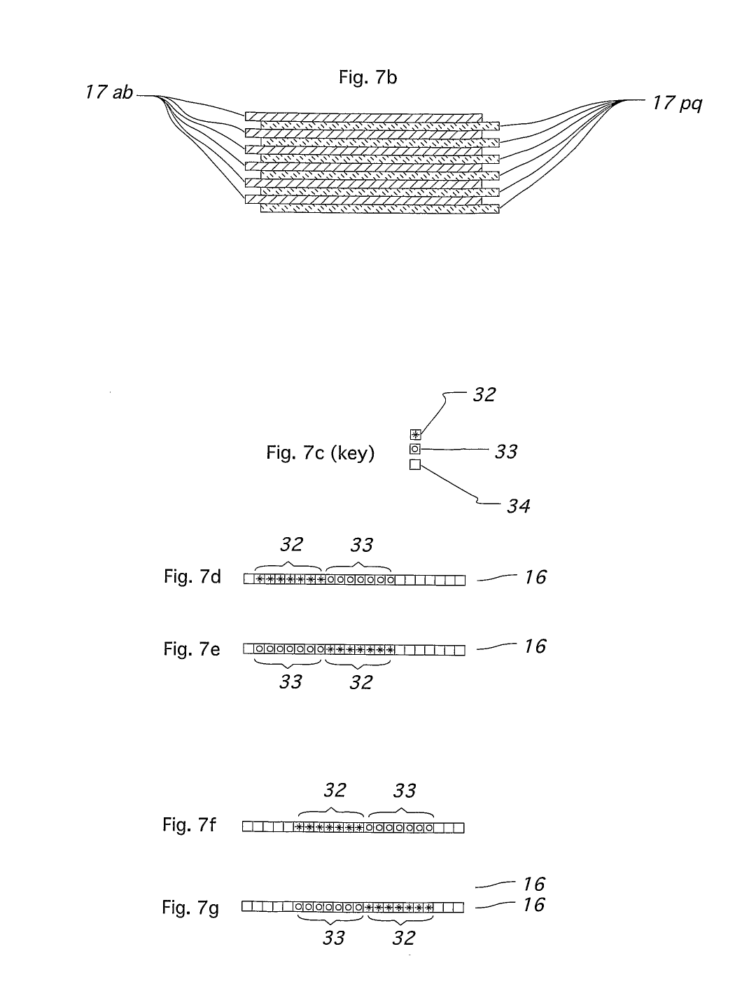

FIG. 7—Hybrid multiplexing with temporal stereo multiplexing and spatial multiplexed for multiple viewers.

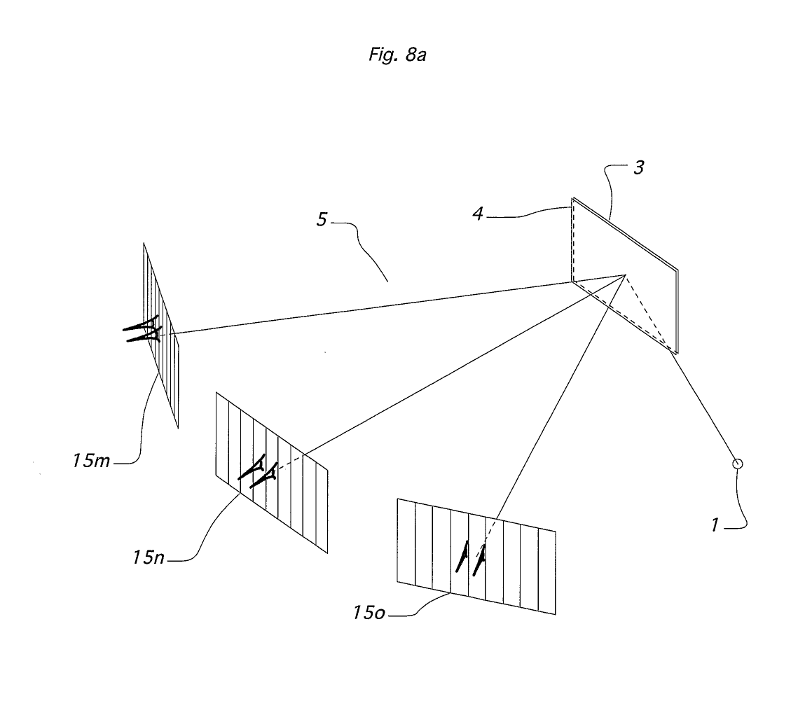

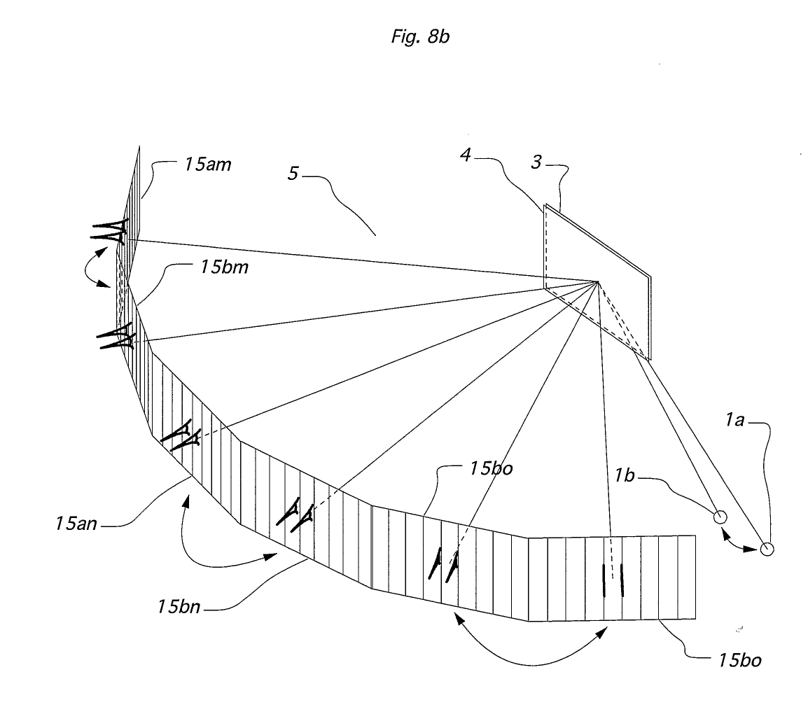

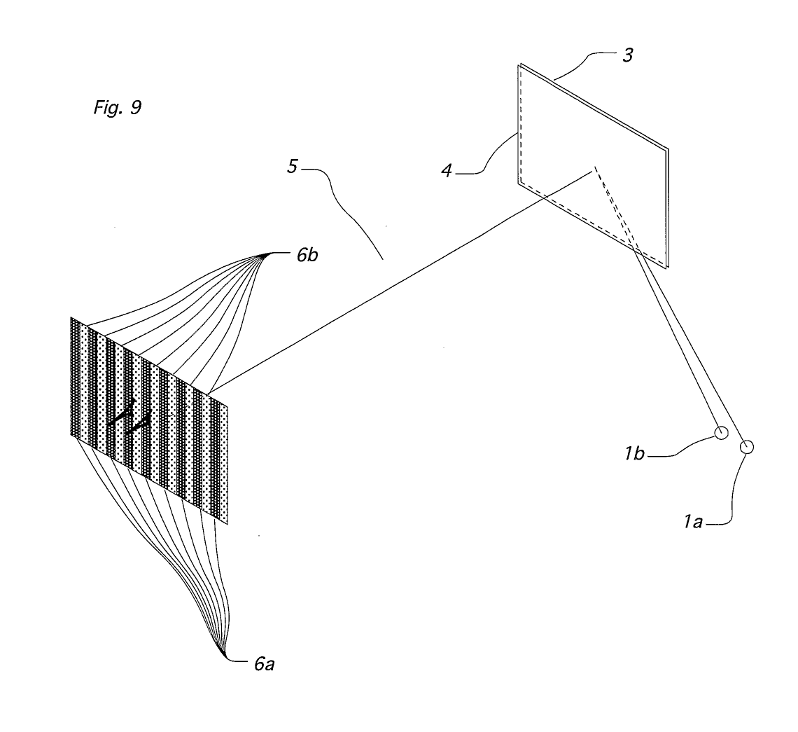

FIG. 8—Multiple-view hybrid spatial and temporal multiplexing I.

FIG. 9—Multiple-view hybrid spatial and temporal multiplexing II.

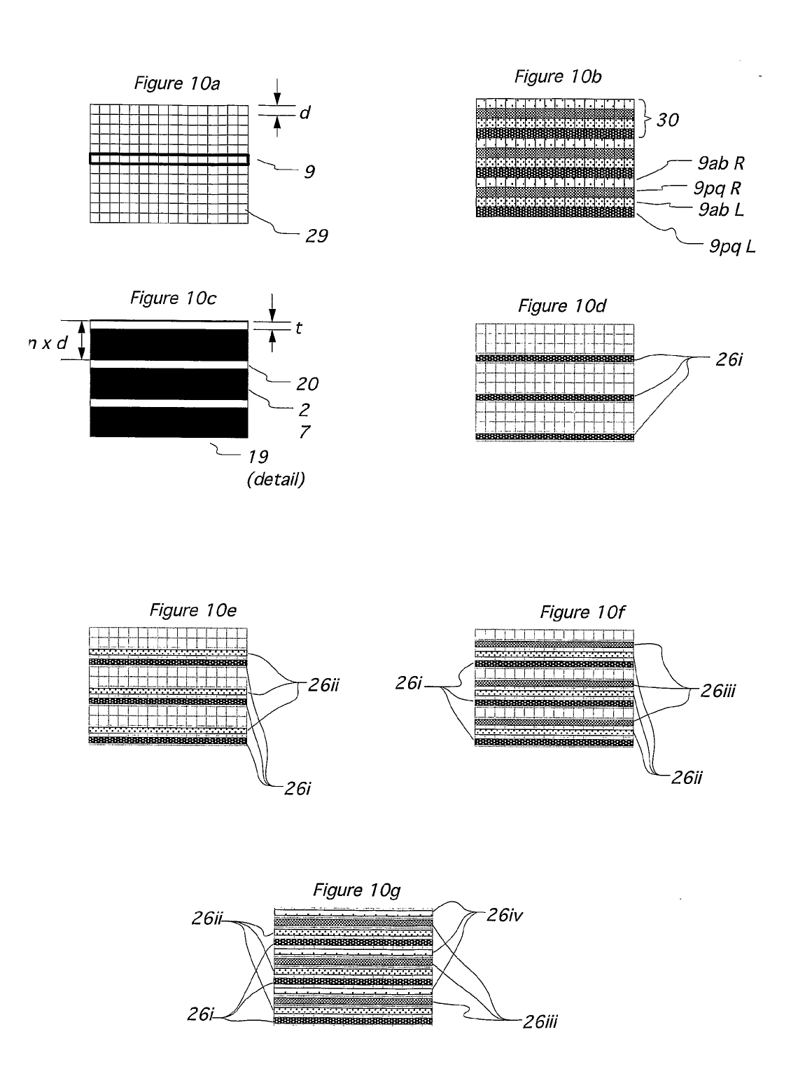

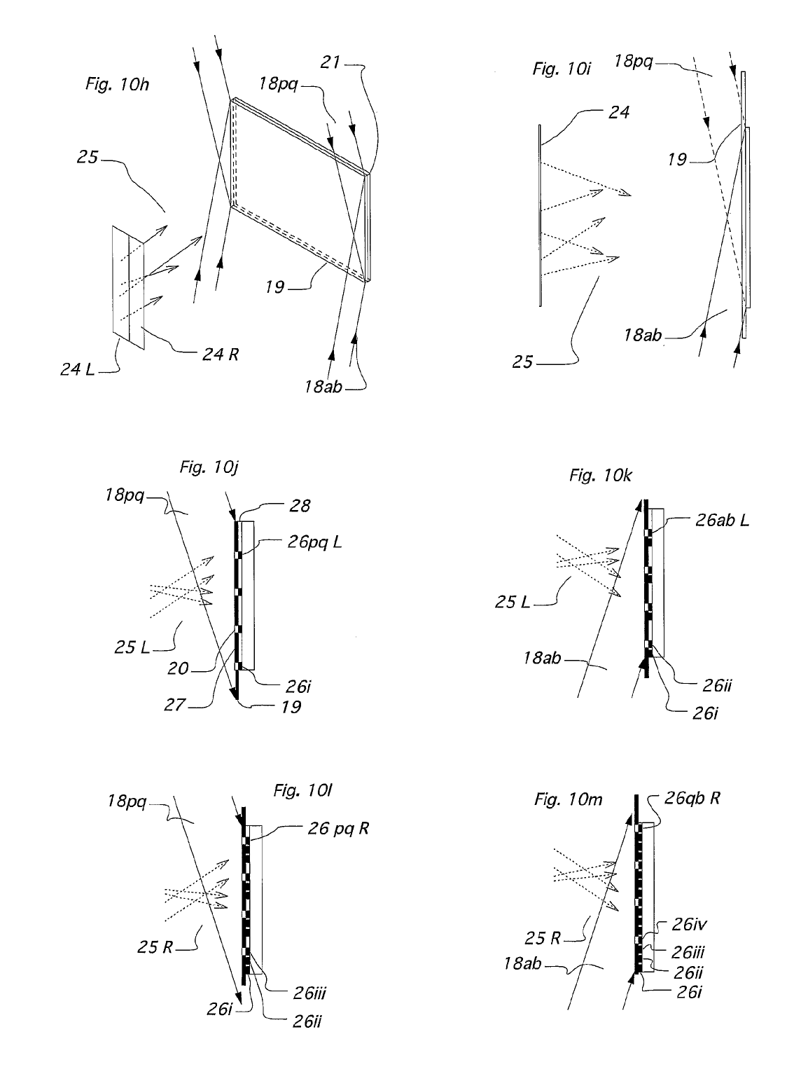

FIG. 10—HOE origination I—spatially multiplexed stereo and temporally multiplexed for multiple viewers.

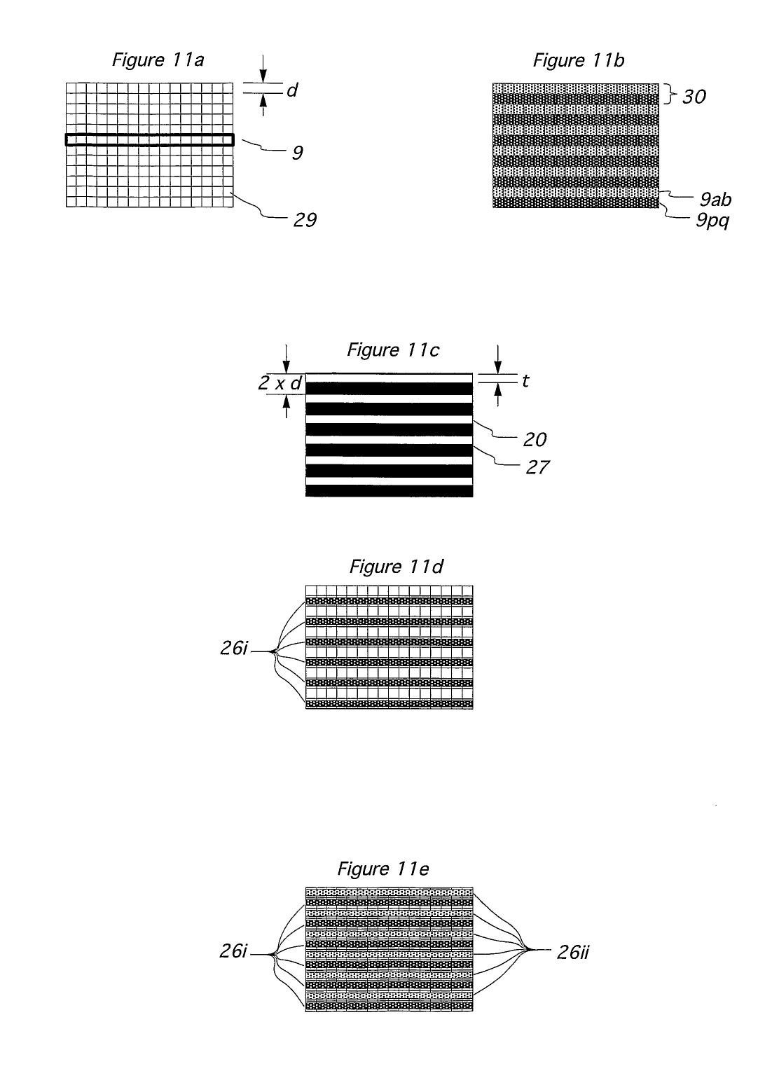

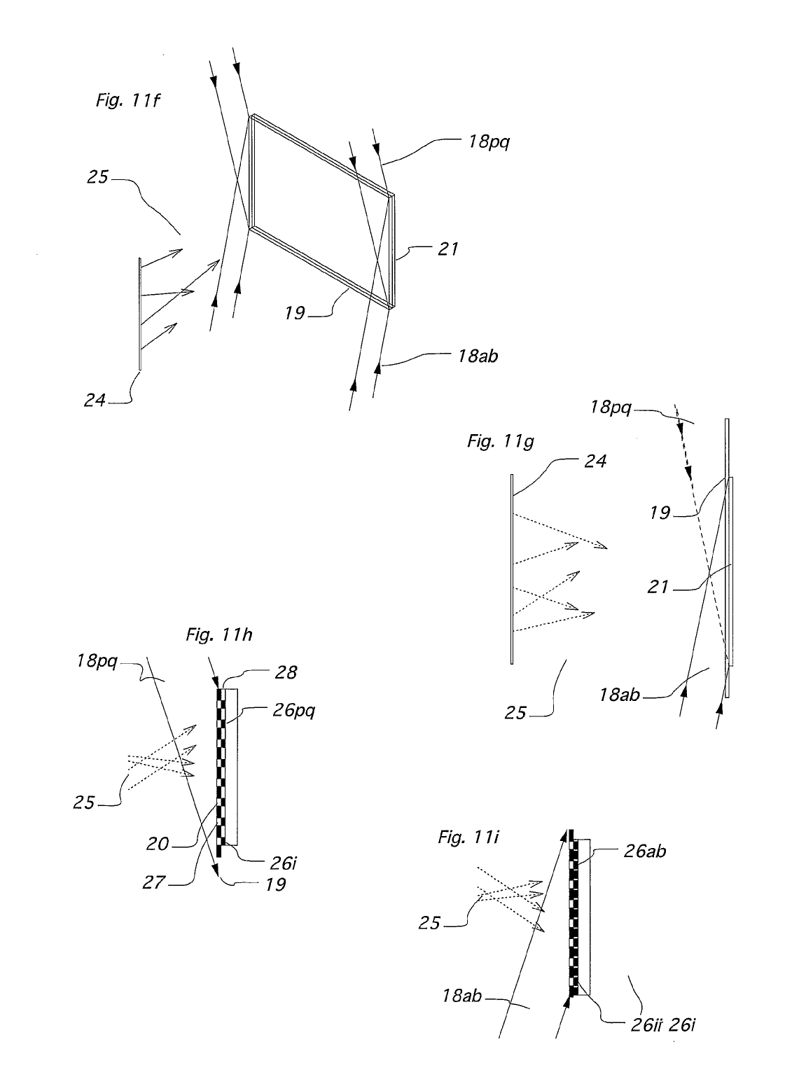

FIG. 11—HOE origination II—temporally multiplexed stereo and spatially multiplexed for multiple viewers.

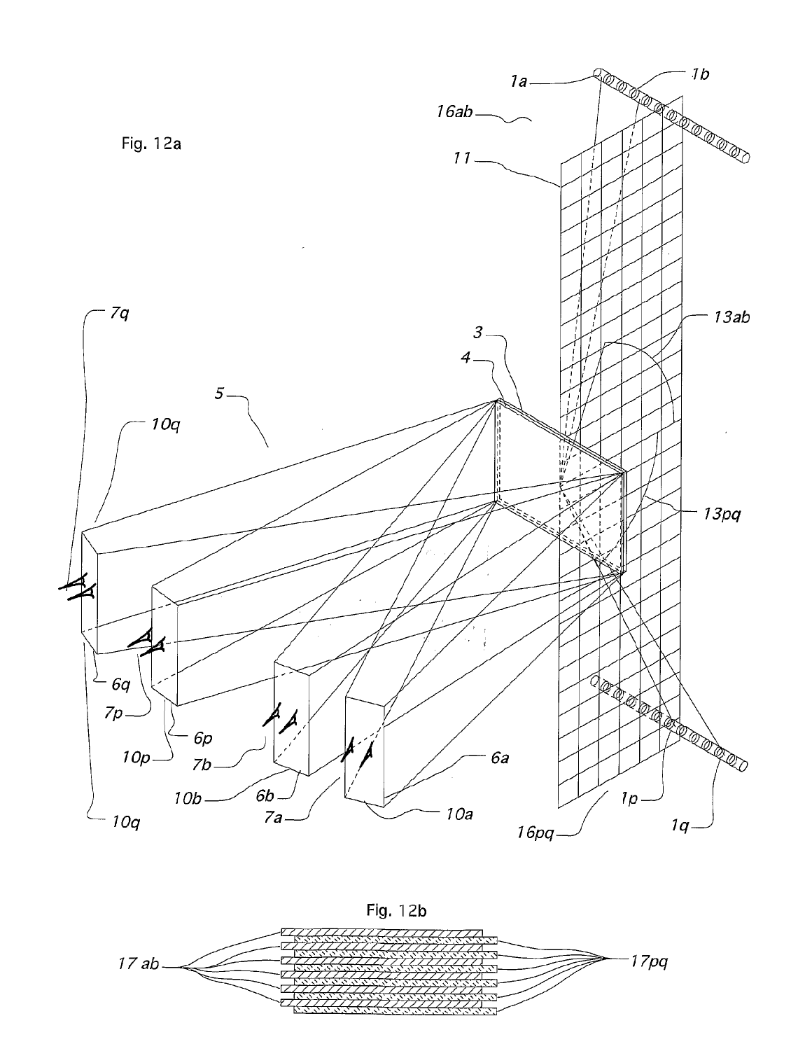

FIG. 12—Hybrid spatial and temporal multiplexing for a 2D display.

FIG. 1: Spatial multiplex EP-A-0764281

FIG. 1a depicts an ASD according to EP-A-0764281. Light source 1 emits the illuminating light 2, which illuminates a spatially multiplexed holographic optical element (HOE) 3. It will be appreciated that the illuminating light 2 will be a wide beam to illuminate the whole of HOE 3 evenly. Such a beam can be configured in a number of different ways. For example it could be contained within a wave-guide, focussed in a number of different ways and might comprise separate red green and blue beams etc. This and subsequent figures have been simplified by showing just single rays of the illuminating light 2 at illustrative angles of incidence. It will be understood that the angle of incidence will depend on the optical configuration used—it will be much larger in the case of the wave-guide illumination method, for example.

The HOE 3 diffracts light through the LCD 4 (FIG. 1 depicts a variant with the LCD 4 placed down-stream from the HOE 3 although it can be upstream). The image bearing means is assumed to be a LCD, but other transmissive displays could be substituted if available. The image displayed on the LCD 4 is a spatially multiplexed stereo image matching the spatial multiplexing of the HOE 3.

The diffracted light 5 forms two abutted planar real images 6L and 6R. Taken together the pair of abutted diffuse real images 6L and 6R form a stereo viewing zone 10. It is appreciated that the real images do not necessarily have to abut one another, and can be spatially separated. A single viewer observing the display with his or her eyes 7l and 7r located as shown will see a 3D stereoscopic image produced by the co-operation of the HOE 3 and LCD 4.

The HOE 3 can therefore be consider to be a spatial filtering means in that it ensures that the visibility of the left component image in the spatially multiplexed stereo image is controlled by the real image 6L, while the visibility of the right spatially multiplexed stereo image is controlled by the real image 6R.

FIG. 1b shows an enlarged detail view of a preferred multiplexing configuration of the HOE 3 in EP-A-0764281. There are two sets of regions 8, the HOE region set 8L diffracts light towards the real image 6L and the HOE region set 8R diffracts light towards the real image 6R. In practice the HOE region sets 8L and 8R are likely to overlap slightly.

FIG. 1c shows an enlarged detail view of the corresponding preferred image multiplexing con-figuration of the LCD 4 in EP-A-0764281. A stereo pair is rendered such that the left image is displayed by alternate lines of pixels 9L, while the right image is displayed by alternate lines of pixels 9R.

The HOE 3 and the LCD 4 are arranged to work together to generate an autostereoscopic image.

Staying with preferred embodiments in EP-A-0764281, FIG. 1d shows the case where there is a light source array 16, three light sources 1a,b,c have been identified in the light source array 16. Each light source 1a,b,c generates a corresponding stereo viewing zone 10a,b,c. If all three light sources 1a,b,c are on at the same time three viewers (represented by their eyes 7) all then perceive the same stereoscopic image displayed by the LCD.

FIG. 1d also illustrates a different viewing mode; the light sources 1 comprising the light source array 16 can be controlled through switching so only one stereo viewing zone 10 is formed at any one time. The position of the stereo viewing zone will change according to which of the light sources 1 in the array 16 are switched on. This can be arranged so that the stereo viewing zone 10 moves in response to a single viewer's movement so he or she can move in front of the display without loosing the stereoscopic image.

If the stereoscopic pictures displayed by the LCD 4 are also updated with perspective views calculated to correspond with the viewer's position relative to the display then full (x, y and z) parallax will be enjoyed by the viewer.

This is a powerful effect but suffers from the limitation that only one stereo pair is displayed so either multiple viewers (such viewers can be mobile and individually tracked) see the same image without proper parallax, or just one viewer sees parallax.

FIG. 2: Temporal multiplexing U.S. Pat. No. 5,600,454

FIG. 2a shows the operation of a display according to U.S. Pat. No. 5,600,454. Two light sources 1L and 1R illuminate the HOE 3 alternately in rapid succession. The HOE 3 diffracts the light such that when illuminated by light source 1L it produces the real image 6L and when illuminated by light source 1L it produces the real image 6R. The location of the pair of positions L and R of the real image 6 is identified as the stereo viewing zone 10. The LCD 4 displays left and right images in synchronisation with the alternating light sources 1L and 1R. Thus when light source 1L is on (1R being off), the LCD displays the left image of a stereo pair, the HOE reconstruct the planar real image 6L and the viewer's left eye 7L sees the left image (the right eye 7R sees nothing). This is then followed by the LCD displaying the right image, light source 1R turns on (1L turns off), the HOE 3 reconstructs the planar real image 6R and the viewer's right eye 7R sees the right image. Provided the images alternate quickly enough, a temporally multiplexed stereoscopic image will be enjoyed by the viewer.

The visibility of the left and right images is determined by synchronising the display of component images and the direction of the illumination, the temporally multiplexed stereo images are thereby temporally filtered by the synchronised illumination.

FIG. 2b shows the same principal applied to multiple viewing positions. In an ideal world—one where LCDs refresh as fast as one wants—such a display might function as follows. Light sources 1aR,1aL, 1bR,1bL, 1cR,1cL light in rapid succession. Six images are displayed successively by the LCD in synchronisation with the light sources 1. The stereo viewing zones 10a,10b and 10c are generated and the three pairs of eyes 7a,7b,7c see unique stereoscopic images. Such a display could independently provide full parallax for a number of different people.

For comfortable viewing, each eye should not be exposed to an image refreshing at less than about 60 Hz, so the LCD would need to fully refresh at at least 6×60=360 Hz. It is also debatable whether 60 Hz is fast enough for time-multiplexed stereoscopic displays. It is clear is that providing multiple different stereo views just using temporal multiplexing is difficult.

There is also a third mode illustrated by FIG. 2b whereby three mobile viewers all enjoy the same stereo image. Here light 1aR,1bR and 1cR are all on simultaneously alternating with lights 1aL,1bL and 1cL which also flash together. The LCD refreshes with just one left and one right image alternately.

General discussion on resolution

The present inventors have recognised that what is required is to deliver a different image to every eye that is observing a display screen. Eyes are arranged in pairs, so the task reduces to directing pairs of images to every viewer.

Any display screen such as an LCD has finite spatial resolution set by the number of pixels. It also has a finite temporal resolution set by its maximum refresh rate.

Taking some reasonable illustrative figures: the limiting figure for the refresh rate is set by the human visual system—a refresh rate of less than around 60 Hz will produce a picture that will flicker disagreeably. In temporal multiplexing the aim is to display different images in rapid succession, in the present case each image is directed to a different eye/eye pair. If the lowest acceptable refresh rate is 60 Hz (it is acknowledged that this figure can be debated and 75-100 Hz is better, but the principle holds) then a display that refreshes at 120 Hz will be able to display two images (one stereo pair) and the display needs to refresh at ≧3×60=180 Hz in order to display three images etc.

The display's refresh rate therefore limits the number of images that individual pixels can be used to display. In an autostereoscopic display according to U.S. Pat. No. 5,600,454 present-day LCDs would be limited to just a single stereo pair and would need refresh rates of at least 240 Hz to display two stereo pairs. (It should also be noted that the images need to switch fully as ghosting—where an earlier image remains slightly visible when the next one is displayed—is unacceptable in stereoscopic applications and this makes the task more challenging).

Spatial resolution can also be divided to produce stereo images, as shown in EP-A-0764281. In the simplest case of spatial multiplexing odd numbered pixel rows on the display can be used to display a left stereoscopic half-image and the even lines the right half-image. In such a case spatial resolution is simply being shared between the two stereo half-images.

The importance of viewer position in 3D stereoscopic displays

The relative novelty of 3D displays has meant that their implementation remains simplistic at the time of writing and the desirability for each of a number of individual viewers to be able to see different stereoscopic images when viewing the same screen has not been fully appreciated. No similar need exists in the field of normal 2D displays since the nature of a 3D image is quite different and the location of the viewer is much more important. Viewers in different locations should be able to see images which are rendered with a perspective that corresponds to their position relative to the image. Otherwise someone viewing from, say, towards the left side of a screen may have to view a 3D image that has a perspective drawn from the right hand side of the image, in such cases a viewer located on the left will see a distortion. Similarly, if the viewer moves relative to the screen displaying a 3D image then the human visual system expects to see parallax—to look around this image. If there is no parallax then the 3D image is seen to distort.

So a viewer using a 3D display should see a picture that is rendered with a perspective that relates to his position and that a second viewer of the same screen should see an image rendered according to her position. Any viewer should see his or her “own” image; ideally the number of such viewer-position-dependent stereo images should equal the number of viewers.

Hybrid multiplexing

Temporal and spatial multiplexing of stereoscopic images have traditionally been considered as alternative approaches. Modern displays have good resolution in both space and time and a carefully designed system can make efficient use of the resolution to provide individual stereoscopic images to a number of viewers.

For example, if a LCD has a 180 Hz refresh rate it can provide separate 3d images to 3 viewers with a spatial multiplexing regime that divides the spatial resolution equally between left and right images. Similarly, if the spatial multiplexing provided two stereo pairs that are individually steerable and the refresh rate was 240 Hz then 2×240/60=8 individual viewers could each see their own personal 3D image at the same time.

The present disclosure identifies how this may be achieved using HOE-based autostereoscopic methods.

Glasses based variant

The principle of hybrid statio-temporal multiplexing can be applied to glasses-based stereoscopic displays as well as autostereoscopic displays, albeit in a limited way.

There are currently two approaches to glasses-based stereo applied to LCD screen.

In one case the image is spatially multiplexed where each pixel row is aligned with a polarising film placed on the front surface of the display. Alternate pixel rows are used to display the left and right images of a stereoscopic pair and alternate strips on the polarising film are disposed in such a way as to polarise even rows in one direction and odd rows in an opposite direction. In one form alternate rows—and therefore the left and right images—are linearly polarised at +45° and −45° respectively, in another form they are right and left circularly polarised. It is appreciated that other polarisations can be used, as long as the left and right images are polarised in opposite senses. The viewer is equipped with special polarisation filtering glasses constructed so as to allow the left eye to see the left image (the right image being blocked by the polarisation filter) and the right eye to see the right image but not the left.

A stereoscopic image is then enjoyed by the viewer. This is a well-known technique where polarisation is used to effect spatial filtering.

The second glasses-based method uses temporal multiplexing. In this case the left and right images are displayed on the screen in rapid succession and the viewer wears special glasses whose lenses are made to be transparent and opaque in rapid succession and in synchronisation with the changing image displayed on the screen. Accordingly, the left eye lens is transparent when the left image is being displayed and the right lens is opaque. The right lens then becomes transparent and the left opaque when the right image is displayed. Each eye therefore see the correct image and a stereoscopic 3D is enjoyed by the viewer. In this case the glasses perform the function of temporally filtering of the two component images of the stereo pair.

In an embodiment of the present invention, a first stereo image is displayed on a spatially multiplexed screen equipped with the polarising filter array described above. Then a second and different stereo image is displayed and these two stereo images alternate in rapid succession. One viewer is equipped with glasses that have polarisation filtering lenses to filter the left and right images properly and in addition a shutter device which renders both lenses opaque when the other viewer's image is being displayed and transparent when the viewers own image is being displayed. The other viewer is equipped with similar glasses which are transparent when the first viewer's glasses are opaque and vice versa.

In another embodiment of the present invention, the two viewers' images can be separated by dedicating one polarisation state to one viewer and the second to a second viewer and then temporally multiplexing the stereo for both viewers. In this case the screen devotes one set of pixel rows (and therefore one polarisation state) to one viewer who wears glasses to select just that polarisation state, the left and right images are temporally multiplexed so the same glasses will also be equipped with alternating transparent/opaque lenses to select the left and right images. The other viewer has glasses with the same configuration except that the opposite polarisation state is selected.

Only two polarisation states can be separated in this way so if polarisation is used to distinguish between viewers the maximum number of different stereo images that can be displayed is just two. The temporal multiplexing is limited in practice by the speed of the display.

If polarisation is used to distinguish left and right images (as opposed to distinguishing between stereo pairs) then the refresh rate needed for a certain number of viewers enjoying their own stereo image can be found by multiplying the number of viewers by approximately 60 Hz.

It will be noted that the number of spatially multiplexed stereo pairs is limited by the ability to distinguish between the pairs. In the glasses-based stereo systems discussed above only one stereo pair can be spatially multiplexed at any one instant because the polarisation filtering can only distinguish between two states—corresponding to left and right images in a stereoscopic system.

In order to further increase the number of viewers the spatial resolution needs to be shared. If the spatial resolution is divided by four so as to generate two separate stereo pairs then the refresh rate required for N viewers halves—the minimum refresh rate is then N×60/2 Hz. So a 180 Hz display can provide separate stereo images to six people. But this is not possible if the only spatial filtering method relies on polarisation.

In the above description, first and second different images are displayed by the screen in order to provide the viewer with a 3D stereoscopic image. It is appreciated that the first and second images can in fact be the same image, such that the viewer sees a 2D final image.

FIG. 3: Multiple viewers by spatial multiplexing and Bragg condition filtering.

Spatial multiplexing for multiple viewers presents a key difficulty. Take the case of two stereo pairs, one intended for one viewer and the other for a second viewer, if they are being displayed simultaneously (as opposed to being multiplexed in time) how can a display be configured so that each viewer sees the correct image—as opposed to both viewers seeing both images? The present inventors provide a solution using HOE-based autostereoscopic methods, as described below.

HOEs are diffractive structures and as such they display angular selectivity. If the HOE has the characteristics of a volume hologram, it's diffraction efficiency will depend on how well the Bragg condition is satisfied by the angle of incidence and wavelength of the illuminating light. Even if some light is diffracted by the HOE when illuminated at a non-optimum angle it can be arranged so that the diffracted light is directed such that it is not perceived by a viewer.

FIG. 3a shows an embodiment of a display device where the HOE 3 is illuminated by two light sources 1a and 1p, and FIG. 3b shows an enlarged detail of the face of the HOE 3 (the patterning in the figure is there to assist clarity and does not represent any actual structure) and depicts how the HOE 3 might be spatially multiplexed. The HOE comprises four region sets 8aL, 8aR, 8pL, 8pR. The region sets 8aL, 8aR are made to diffract light when illuminated from one direction while the region sets 8pL, 8pR diffract light when illuminated from a substantially different direction.

Returning to FIG. 3a, the illuminating light 2a emitted by light source 1a is diffracted by the region sets 8aL, 8aR and reconstructs the stereo viewing zone 10a. Similarly the illuminating light 2p emitted by light source 1p is diffracted by the region sets 8pL, 8pR and reconstructs the stereo viewing zone 10p.

The LCD 4 displays spatially multiplexed images which are aligned with the HOE region sets 8. To achieve full parallax eye 7aL and 7aR should see a stereo picture whose perspective matches their position relative to the display and which changes as their position changes. The same should happen for eyes 7pL and 7pR.

It will be clear that the lateral displacement angles 12a and 12p can be independently altered in real time by changing the (apparent or physical) location of light sources 1, one effective way of achieving this would be to switch between the individual light sources 1 in the light source arrays 16a, 16p. This allows the independent movement of the stereo viewing zones 10a and 10p.

The effect of the difference in the vertical illumination angles 13a and 13p is to allow the independent control of the positions of the stereo viewing zones 10a and 10p.

A vertical reference plane 11 normal to the plane of the HOE 3 has been shown to assist in under-standing the orientation of the angle of incidence of the illuminating light 2a and 2b in the drawing.

Careful design of the illumination and further spatial multiplexing of the HOE 3 will allow the provision of additional independently-steerable stereo viewing zones 10 by further exploiting the angle-dependency of the HOE 3.

Different light sources within a single light source array provide spatially displaced viewing zones, and it is anticipated that for the vast majority of use, the same can be said for different light sources from different arrays. However, it is possible for different light sources from different arrays to provide viewing zones in the same spatial location. This could be for calibration purposes, for example.

Preferably, the eye 7aL should see the left image of a stereo pair, and the eye 7aR should see the right image of a stereo pair, and similarly for other pairs of eyes. However, it is appreciated that the images seen by different eyes can in fact be the same image, such that the viewer experiences a 2D final image. One viewer may be provided with a 3D stereoscopic images and another with a 2D image, to satisfy individual requirements.

FIG. 4: Spatio-temporal multiplexing—spatially multiplexed for stereo, temporally multiplexed for multiple viewers, no Bragg filtering.

FIG. 4a shows the use of temporal multiplexing combined with spatial multiplexing. In this embodiment the temporal multiplexing does not provide a stereo image but is used to allow spatial multiplexing to provide independently steerable stereo viewing zones. The HOE 3 effects spatial filtering of stereo pairs while temporal filtering is used to direct the spatially multiplexed stereo images such that a first spatially multiplexed image is seen by one viewer and a second spatially multiplexed image is seen by a second viewer.

FIG. 4a shows a light source array 16. Within the array 16 two light sources 1a and 1b are disposed on opposite sides of the reference plane 11, their lateral displacement is represented by the angles 12a and 12b respectively. FIG. 4b shows that the spatial multiplexing of the HOE 3 will produce one stereo viewing position 10 when illuminated by one light 1. Both HOE region sets 8a and 8b diffract light with broadly the same vertical illumination angle 13.

When light source 1a is on, the stereo viewing zone 10a is produced and when light 1b is on the stereo viewing zone 10b is produced. The LCD 4 (not show in this figure but mounted in front or behind the HOE as before) should have a fast refresh rate and switch alternately between the spatially multiplexed stereo view appropriate for the eye pair 7a and that for eye pair 7b. The light sources 1a and 1b are alternately illuminated in synchronisation with the change in the spatially multiplexed stereo images displayed by the LCD 4.

The location of the light sources 1a and 1b may be changed in real time simply by using different light sources in the light source array 16, thereby allowing the eyes 7a and 7b to be tracked and appropriate perspective views displayed for each viewer.

Two independent stereo viewing zones 10a and 10b are shown, the number of such zones will be limited by the refresh rate of the LCD. It is reasonable to take the current minimum refresh rate for computer monitors (60 Hz) as the minimum refresh rate for this use, in which case 2 independent viewing positions will require a refresh rate of 120 Hz and three positions will need 180 Hz etc.

Again, similarly to in the previous embodiments, a 2D image can be enjoyed by a viewer by providing both eyes of the viewer with the same image.

FIG. 5: Spatio-temporal multiplexing—spatially multiplexed for stereo with Bragg filtering, temporally multiplexed for multiple viewers.

FIG. 5a shows an embodiment having two light source arrays 16ab and 16pq. Two individual light sources 1a, 1b have identified within the light source array 16ab and a further two light sources 1p, 1q within the light source array 16pq.

FIG. 5b is an enlarged detail showing spatial multiplexing of the HOE 3. The light 2 emitted by light sources 1a and 1b is diffracted by the HOE region sets 8abL and 8abR. When light source 1a is on the diffracted light forms the stereo viewing zone 10a, similarly light from light source 1b will be diffracted to form the stereo viewing zone 10b. The displacement between the stereo viewing zones 10a and 10b is a function of the angular separation of the two light source 1a and 1b, namely lateral displacement angle 12a plus lateral displacement angle 12b.

Light sources 1a and 1b alternate in synchronisation with changing images displayed by the lines of pixels on the LCD 4 (not shown in this figure) corresponding to the two HOE region sets 8abL and 8abR.

By this means one stereo pair is displayed for a viewer at the stereo viewing zone 10a and a different one for a viewer at the stereo viewing zone 10b.

The same procedure can be applied to lights 1q and 1p, the HOE region sets 8pqR and 8pqL and corresponding lines of pixels 9 on the LCD 4 (not shown), with similar results for the stereo viewing zones 10p and 10q.

By altering which of the lights in the arrays 16ab and 16pq are used four mobile viewers can retain stereo images, assuming the refresh rate is 120 Hz, six viewers if it is 180 Hz and eight viewers if it is 240 Hz etc. Each of these can be perspective-updated to provide each viewer with correct full parallax.

This hybrid multiplexing configuration shows:
Two stereo viewing zones 10ab . . . and 10pq . . . produced by spatial multiplexing of the HOE 3.
Angular (Bragg condition) multiplexing allows the positions of the two stereo viewing zones 10 to be controlled independently.
Temporal multiplexing doubles the number of independently steerable stereo viewing zones 10 to four in the case of a LCD with a refresh rate faster than ≈120 Hz, six if it is faster than 180 Hz etc.

In this case the vertical resolution has been divided by four, with the horizontal resolution unaffected; and the temporal resolution has been halved. Any stereo quantisation effects are determined by the horizontal pixel pitch of the LCD resolution and are therefore optimum and will be undetectable, full and correct x, y and z parallax is provided for 4 or more independent, mobile viewers.

It will also be possible to use more than the two different vertical illumination angles 13ab and 13pq and use angular multiplexing combined with further spatial multiplexing to provide more independent viewing positions.

At this point it should be noted that the Bragg condition multiplexing allows the independent control of the regions of spatial multiplexing represented by HOE region sets 8 and their associated lines of pixels 9 on the LCD 4. Consequently an increase in the number of illumination angle dependant multiplexed channels will result in a concomitant reduction in the spatial resolution available for each channel. Temporal multiplexing has no impact on the spatial resolution and has the effect of multiplying the number of views provided by spatial multiplexing by the amount of different pictures the LCD can display sequentially without flicker or other intrusive time-related artefacts becoming intrusive.

In the case of temporal multiplexing the timing of the illumination is likely to be quite critical. It is possible that multiple flashes for one image will help reduce flicker by increasing the apparent flicker frequency—in a similar way to how flicker is reduced in film projectors by increasing the flicker rate above the flicker fusion threshold (typically to three times the frame rate). Careful control of the lighting timing may also help to reduce crosstalk and increase the contrast ratio.

In the above description, it is preferable to provide a viewer with a 3D stereoscopic image by providing left and right images of a stereo pair. It is appreciated, however, that the first and second images can in fact be the same image, such that the viewer with a 2D final image.

FIG. 6: Spatio-temporal multiplexing—spatially multiplexed for stereo with polarisation filtering, temporally multiplexed for multiple viewers.

The Bragg condition multiplexing uses angular selectivity to filter the light and select light from the appropriate source. Other filtering methods may also be used, as alternatives or in addition to angular and/or temporal multiplexing.

FIG. 6 shows an embodiment using polarisation filtering combined with temporal multiplexing.

FIG. 6a shows two light source arrays 16ab and 16pq. Light emitted from a light source 1 in the light source array 16ab is polarised one way (linear polarisation at +45° would be convenient) by polarising filter 31ab, while light from sources 1 in light source array 16pq is polarised in the opposite sense (say −45°). It is appreciated that other polarisation configurations can be used. An array of linear polarising filters 14 is placed directly behind HOE 3.

FIG. 6b is a cut-away, enlarged detail shown from the illumination side where the LCD 4, HOE 3 and polarising filter array 14 are assembled together in registration.

The polarising filter array 14 is spatially multiplexed such that it comprises two sets of regions distinguished in that one set passes light polarised in one polarisation state AB (say +45°) while the other set passes it in an orthogonally orientated state PQ (say −45°).

Thus light from light source 1a in the array 16ab is blocked by the set of regions of the polarising filter array 14pq while passing through the set of regions of the polarising filter array 14ab. Consequently, the HOE 3 will generate the stereo viewing zone 10a. Similarly, light from light source 1p in the array 16pq is blocked by the set of regions of the polarising filter array 14ab while passing through the set of regions of the polarising filter array 14pq. Consequently the HOE 3 will generate the stereo viewing zone 10p.

Using of polarisation multiplexing here enables two distinct and separately-controllable stereo views to be generated.

This is then coupled with temporal multiplexing to alternate the views 10a and 10p with 10b and 10q.

Appropriate choices of the light sources in the arrays 16 allow multiple viewers to be tracked and to be provided with their own unique stereo images.

A LCD is polarisation dependant so the image displayed on the pixel lines 9ab and 9pq will need to be adjusted to take into account the none-standard polarisation state of the light. Alternatively, the polarisation can be altered after it has been filtered.

Polarisation can be used to filter two channels of light, the angular method can provide more channels. The two methods can be used in conjunction with each other.

FIG. 7: Spatio-temporal multiplexing—temporally multiplexed for stereo, spatially multiplexed for multiple viewers.

The roles of the spatial and temporal multiplexing can be reversed—the temporal multiplexing can be used to provide stereoscopic images while the spatial multiplexing is used to distinguish between viewers.

FIG. 7a shows an embodiment where two mobile viewers each enjoy different stereoscopic images. FIG. 7b is a detail showing the structure of the HOE 3.

In FIG. 7b the HOE 3 comprises two sets of regions 17ab and 17pq. The hologram regions of the set 17ab are designed and made such that they diffract light incident on the HOE only at angles close to angle 13ab. Similarly the hologram regions of the set 17pq are designed and made such that they diffract light incident on the HOE only at angles close to angle 13pq.

All sets of regions 17 can diffract light to form the real images that make up the viewing zones 6. The location of the viewing zones 6 might be the same for all the hologram regions 17, or they might be different.

The set of regions 17 are design to diffract light through different set of pixels in the LCD. So the HOE regions 17ab might diffract light though only odd-numbered rows of pixels in the LCD, while the HOE regions 17pq might diffract light though only even-numbered rows of pixels in the LCD. Consequently, An image that is displayed only on odd-numbered rows will only be visible when a light or lights in the array 16ab are on, similarly an image that is displayed only on even-numbered will only be visible when a light or lights in the array 16pq are on. Furthermore the same images will only be visible in areas determined by the location of the corresponding real images 6.

Thus, if a light source 1a in light source array 16ab in FIG. 7a is on, the hologram regions comprising set 17ab diffract light to form a real image 6a and the picture displayed by the odd-numbered pixel rows in the LCD 4 will be visible to eye 7a. If light source 1a switches off and light source 1a′ is switched on, then eye 7a no longer sees any picture on the odd-numbered lines of LCD 4 but eye 7a′ does. If (a) the two images displayed on the odd-numbered lines of LCD 4 are a stereo pair, and (b) they alternate is rapid succession and (c) the lights 1a and 1a′ also switch on and off correctly synchronised with the display of the said pictures then eye 7a sees the right image of the stereo pair and eye 7a′ sees the left image and an autostereoscopic 3D image is then perceived by the viewer. This autostereoscopic image is displayed in sequential left/right pairs by the odd-numbered rows of pixels on the LCD 4. It is appreciated however, that the two images displayed on the odd-numbered lines of the LCD 4 may be the same image in order to provide the viewer with a 2D image.

The location of the viewing zone 10a is determined by the location of the real images 6a and 6a′, which in turn is determined by the location of the light sources 1a and 1a′ in the light source array 16ab. Similarly, the stereo viewing zone 10b is formed by light sources 1b and 1b′. Thus the correct choice of light sources 1 can be used to move the position of the viewing zone 10 so as to track a mobile viewer.

It will be appreciated that light sources in the array 16pq can also be used to generate mobile viewing zones 10p, 10q etc., with the important difference that the stereo image is composed of the picture displayed on the even-numbered rows on the LCD. Consequently each of two viewers will see different stereo images.

It will also be appreciated that additional sets of HOE regions 17 can be added and that several corresponding light source sets can be provided which illuminate the HOE at sufficiently different angles 13 so that no set of regions 17 diffracts light illuminating the HOE from any angle 13 except approximately its design angle. The limit on the number of such sets 17 is set by (a) the tolerable loss in spatial resolution in the LCD (which equals the base physical resolution divided by the number of such sets), (b) the optical characteristics (specifically the Bragg angle selectivity) of the holographic material used and (c) the maximum tolerable thickness of the display, which is an industrial design question.

It will also be appreciated that polarisation could be used as an alternative or additional filtering method as and alternative (or in addition) to Bragg condition selectivity.

FIGS. 7c,d,e,f,g show a schematic detail of a light source array 16 that could be used in a display of this type if the HOE 3 is made using a narrow diffviewer as shown in FIG. 11. Rather than using single point sources of light, a sub-array of lights along a linear array can be used.

FIG. 7c is a key to FIGS. 7d,e,f,g. The light source 32 to be used for a viewer in a particular position is shown marked on; the light source 33 to be used for a viewer in a particular position is shown marked off; the light source 34 is not to be used for a viewer in a particular position and is off.

FIG. 7d shows an array of light sources 16, a group of seven light sources 32 are in the on condition when, say the left image is being displayed on the LCD 4 and they co-operate together to re-construct a diffuse real image 6, all other lights are off.

FIG. 7e sows the same array of lights 16 and it will be noted that different lights 32 are now on, this coincides in time with the display of the second image in the stereo pair and the light emitted reconstructs a diffuse real image 6′.

FIGS. 7f and 7g show the same two states except different lights are being used, so the position of the diffuse real image pair 6 and 6′ will form in a different location.

Thus it is the join between the group of lights 32 and 33 that determines where the join between the left and right parts of the stereo viewing zones 10 is located, and this can be controlled so that it is located between the eyes 7 and 7′.

FIG. 8: Multi-view autostereoscopic display type 1.

Spatio-temporal hybrid multiplexing can also be applied to multi-view displays. EP-A-0764281 provides for multi-view implementations. While EP-0764281 describes a good method (which has several advantages over lenticular and parallax barrier methods) it inevitably suffers from the same trade-off between 2D resolution and 3D resolution. Hybrid multiplexing can, however, improve the situation in a number of ways.

FIG. 8a is a right isometric perspective view not to scale. It depicts a multi-view ASD made according to the methods of EP-A-076428. One light source 1 illuminates a spatially multiplexed HOE 3 which co-operates with an LCD to generate three composite stereoscopic viewing zones 15m, 15n, 15o. In the illustrated case each composite stereoscopic viewing zone 15 comprises 9 different perspective views (in this case the spatial multiplexing might be in the form of a 3×3 pixel matrix, other arrangements are attractive such as 4×4 or 5×5 giving 16 and 25 views respectively). Each of the composite stereoscopic viewing zones 15 provide the same set of perspective views, the number of such composite stereoscopic viewing zones 15 is determined in the making of the HOE and/or by the illumination configuration used, FIG. 8a shows three such composite stereoscopic viewing zones 15m,15n,15o.

FIG. 8b shows an embodiment of the invention where temporal multiplexing is used to increase the number of views from nine to eighteen by alternating two light sources 1a and 1b, when source 1a is on, a first set of nine views is displayed by the LCD 4 with appropriate spatial multiplexing. These will be visible via the composite stereoscopic viewing zones 15am, 15an and 15ao. Similarly, when light 1b is on a second set of nine views (preferably extending the series of perspective comprising the first set of nine views) will be displayed by the LCD 4 and these will be visible via composite stereoscopic viewing zones 15bm, 15bn, 15bo. Two adjacent views within the viewing zone provide a stereo pair. The width of the viewing zones 15 is thereby doubled without loss of spatial resolution.

Thus temporal multiplexing can be used to at least double the 3D resolution (expressed as the number of perspectives displays within a given angle) that can be used for a given density of spatial multiplexing.

Additional light sources can be used in order to generate further viewing zones.

FIG. 9: Multi-view autostereoscopic display type 2.

FIG. 9 shows a related approach where the temporally multiplexed views interlaced with each other. When light source 1a is on the HOE 3 and LCD co-operate to produce a set of perspective views visible via the set of planar real images 6a. When light source 1b is on the HOE generates the set of planar real images 6b. As before, the pictures displayed on the LCD 4 change in synchronisation with the alternate activation of the light sources 1a and 1b resulting in a doubling of the number of component views displayed.

FIG. 12: 2-D operation

In the above-described embodiments, it has been noted that the autostereoscopic displays can be used in order to display 2D images. An optimum configuration for a 2D display is described herein below.

The same optical principles that have been identified for autostereoscopic displays can also be applied to a 2D display. In this case several viewers would be able to see different images displayed on a single screen. FIG. 12 shows a 2D variation based on the 3D-capable versions shown in FIG. 7.

It should be noted that both these example configurations (FIG. 7 and FIG. 12) rely on both temporal and spatial resolution being divided by two.

In the case of FIG. 7, autostereoscopic operation requires the display to present one image for each eye—so for two mobile viewers the display must present different images to each of the four eyes looking at it. In contrast, 2D operation only requires one image per pair of eyes, so the configuration of FIG. 12 provides different 2D image to four independently mobile viewers while exploiting the available spatial and temporal resolution in the same way.

In FIG. 12, HOE regions 17ab diffract light from light source array 16ab but not light from lights in light source array 16pq; similarly, HOE regions 17pq respond to light from light source array 16pq and not from light source array 16ab. When light source 1a within light source array 16ab illuminates the HOE 3 and LCD 4, HOE regions 17ab, will reconstruct the diffuse image 6a to form the viewing zone 10a HOE; regions 17pq do not respond to light from this direction, so pixels associated with them are not illuminated from light in the light source array 16ab. Similarly light source 1p within array 16pq forms the viewing zone 10p. Thus a first viewer's eyes 7a see only the image displayed by pixels associated with HOE regions 17ab and a second viewer's eyes 7p only the image displayed by pixels associated with HOE regions 17pq.

As previously described, the location of viewings zones 10 depends upon the location of the relevant light source within the light source arrays 16. If two light sources within array 16ab alternate quickly enough to avoid flicker and the image displayed by the associated pixels changes in synchronisation then two viewers (eyes 7a and 7b) can enjoy the different 2D images displayed in sequence by the pixels associated with the HOE regions 17ab.

The same applies to two further viewers (eyes 7p and 7q), light sources within the array 16pq, HOE regions 17pq and their associated pixels. The display therefore provides four different 2D images to each of four viewers.

Any light source can be chosen from within the arrays 16ab and 16pq, consequently the light sources can be selected to provide images to viewers located anywhere within a designed range, all four viewers are therefore able to move around without loosing their “own” 2D image.

If the spatial and temporal resolutions permit, the number of independently mobile viewers that can see different images can be increased by application of this principle. The Bragg angle and/or polarisation filtering methods described in previous embodiments can be applied (as alternatives or in conjunction with each other) so as to facilitate the increase in the maximum number of independent viewers.

HOE fabrication methods: for display in e.g. FIG. 5.

There are a number of fabrication methods that can be used for the HOE 3. Fabrication methods are described in the prior art disclosed herein and there are relevant techniques that are know to those skilled in the art of holography. The following discussion is therefore summary in nature.

Where reference is made to “holographic plate” through this document this can also refer to film (as opposed to glass) coated with a suitable sensitive layer. The use of the term “plate” interchangeably with “film” is a widely adopted habit in the industry.

The HOE production procedure would typically comprise a first step—the production of a master (H1) HOE. The next step might the production of copies from this master, these copies are second generation and known as H2 HOEs, they are used to make the HOE 3 for incorporation in the display, being third generation these are know as H3 HOEs.

FIG. 10 shows a configuration used in the production of a spatially multiplexed H1 master HOE which might be used in a display configured as shown in FIG. 5.

FIG. 10a shows a simple grid that represents the pixel arrangement of a LCD. It is an enlarged detail, in commercial LCDs the pixel pitch d will likely be about 250 μm in the case of a computer monitor, larger in the case of a large flat screen TV. The number of pixels in a LCD (counting each RGB triplet as one pixel) will be of the order of 2 million. FIG. 10a shows a number of pixels 29 in a typical grid arrangement, a single row of pixels 9 has been highlighted.

FIG. 10b shows a spatial multiplexing schema that is similar to that shown in FIG. 5b. The group 30 comprises four rows of pixels 9ab R, 9pq R, 9ab L and 9pq L. Again, this labelling is for the purposes of explanation (other arrangements could be used) and reproduces the labelling used in FIG. 5. The groups 30 repeat over the area of the display.

The H1 HOE can be made using a mask 19. A detail of the mask 19 is shown in FIG. 10c, it comprises an array clear areas 20 separated by opaque areas 27. The pitch of the clear areas is d×n where d is the LCD pixel pitch and n is the number of spatially multiplexed rows (four in this case—corresponding to pixel rows 9ab R, 9pq R, 9ab L and 9pq L). The thickness t of the clear area is ≦d.

The mask 19, HOE 3, LCD 4 and H1 HOE 21 are all of similar size. (In practice the mask 19 and HOEs 3 and 21 will likely be slightly larger than the LCD). The whole area of the mask is covered by the clear lines 20 and opaque lines 27. The clear areas 20 in the mask will therefore align with every fourth row of pixels in the LCD.

FIG. 10h is a right isometric perspective view but is not to scale, it shows the holographic plate 21 with the mask plate 19 placed in front of it and in close contact with the photographically sensitive layer 28 (not shown) of holographic plate 21. One reference beam 18pq is directed towards the mask 19 and holographic plate 20 from above and a second reference beam 18ab is shown similarly directed but from below.

A diffuser 24—which can be a ground glass diffuser, a holographic diffuser or any similarly functioning object, is show in two locations, indicated here as diffuser 24L and diffuser 24R (in practice the diffuser 24 is likely to be a single object which is masked so that first one half is used then the other).

It will be understood that when the finished HOE 3 is reconstructed in a functioning display the real image of the diffuser 24 is the real image 6 in the figures that depict the display, consequently its size, orientation and position affect the functioning of the finished display. (As does the angle, convergence or divergence of the reference beams 18 and the illuminating beams 2). The diffuser 24L corresponds in general to the real image 6 that determines the left half of a stereo viewing zone 10, while diffuser 24R corresponds in general to the real image 6 that determines the right half of a stereo viewing zone 10.

Diffuser 24L scatters light 25L towards the mask 19 and holographic plate 21 and diffuser 24R scatters light 25R in the same manner.

For simplicity, it is assumed here that the central location of the stereo viewing zones 10 is the same for the holographic recordings using reference beam 18ab and that using reference beam 18pq, this is convenient and a reasonable design approach as it allows both of the spatially multiplexed stereo viewing zones 10 to move symmetrically left and right.

FIG. 10i is a side view of the geometry shown in FIG. 10h, it is not to scale.

The four exposures that are needed to record the master HOE H1 21 for this particular arrangement will now be described. with reference to FIGS. 10j,k,l,m, which show and enlarged vertical section and FIGS. 10d,e,f,g, which show enlarged view of the surface of the master HOE 21. Note that in these figure shading is used simply to aid clarity.

1. Exposure 1 is shown in FIG. 10j. The mask is in the first position, the diffuser 24 L is illuminated and scatters light 25L which interferes with reference beam 18pq. This interference pattern is recorded in the sensitive layer 28 in locations corresponding to the clear areas 20 in the mask 19; these are the exposed areas 26pq L (indicating that reference beam 18pq and diffuser 24 L were used in the exposure) and have also been labelled 26i, to show that they are produced by the first exposure. FIG. 10d shows the exposed areas 26i in its position relative to the pixel structure of the LCD it is designed for.

2. Exposure 2 is shown in FIG. 10k. The mask has been translated by the pixel pitch d to the second position; the diffuser 24 L is illuminated and scatters light 25L which interferes with reference beam 18ab. This interference pattern is recorded in the sensitive layer 28 in the locations corresponding to the clear areas 20 in the mask 19; these are the exposed areas 26ab L they are also labelled 26ii. The location of the previously-exposed areas 26i (26pq L) are also shown. The same is represented in FIG. 10e.

3. The diffuser is then adjusted so the diffuser 24L no longer scatters light but diffuser 24R does. The mask is translated by d again to the third position; the diffuser 24 R is illuminated and scatters light 25R which interferes with reference beam 18pq. This interference pattern is recorded in the sensitive layer 28 in the locations corresponding to the clear areas 20 in the mask 19; these are the exposed areas 26pq R they are also labelled 26iii. The location of the previously-exposed areas 26i and 26ii are also shown. The same is represented in FIG. 10f.

4. The mask is translated by d again to the fourth position; the diffuser 24 R is illuminated and scatters light 25R which interferes with reference beam 18ab. This interference pattern is recorded in the sensitive layer 28 in the locations corresponding to the clear areas 20 in the mask 19; these are the exposed areas 26ab R they are also labelled 26iv. The location of the previously-exposed areas 26i, 26ii and 26iii are also shown. The same is represented in FIG. 10g.

HOE fabrication methods: for display in e.g. FIG. 7.

FIG. 11 shows the recording procedure for a HOE H1 master 21 that can be used in a display such as that shown in FIG. 7 (which uses temporal multiplexing to create stereo and spatial multiplexing to deliver different stereoscopic images to two independently mobile viewers).

FIG. 11a identifies rows of pixels 9, as is shown in FIG. 10a. The display in FIG. 7 uses just two sets of rows of pixels; these are identified as 9ab and 9pq.

A detail of the mask 19 is shown in FIG. 11c the pitch of this mask is 2d, where d is the pixel pitch of the LCD. The thickness of the clear areas 20 is t where t≦d.

The H1 recording geometry is shown in FIG. 11f, it will be noted that just one diffuser 24 is used and that it is narrower than the diffuser 24 shown in FIG. 10. It does not need to be narrow but in this case the light sources in FIG. 7 are linear and have the effect of spreading the real image 6 of the diffuser 24 horizontally. The horizontal position of the join between 6x and 6x′ in FIG. 7a is controlled by the choice of light sources in the lighting arrays 16 in FIG. 7.

The reference beams 18q and 18ab are essentially the same as in FIG. 10. There are just two exposures in this case.

1. FIG. 11h shows the mask 19 in the first position; reference beam 18pq interferes with scattered light 25 and is recorded by the sensitive layer 28 at the locations 26pq, also shown as 26i. The pattern of this recording is shown in FIG. 11d.

2. The mask is then translated by pixel pitch d to the second position as shown in FIG. 11i and a similar recording is made using reference beam 18ab, the resulting recording is shown at FIG. 11e

The two H1 recording procedures discussed above can be varied according to the detailed requirements of a particular display. There are also other holographic procedures, which can deliver equivalent optical performance. One implementation of displays according to this invention will be to use “edge-lit” holographic geometries where the illuminating light is contained within a transparent light guide. Such geometries allow the display to be made in attractively thin forms. The methodologies used to make edge lit hologram are known, so they will not be discussed here.

H2 and H3 replication

One procedure for making the final HOE 3 can be simply described. An intermediate H2 HOE is first made by a contact copying procedure where the finished H1 is placed in contact with an unexposed plate (sensitive layer to sensitive layer) and the whole exposed using laser beam that are the conjugate(s) of the reference beam(s) used in the recording of the H1, the HOEs are transmission holograms so the light passes first through the H1 which reconstructs real image(s). The light forming the image(s) interferes with the zero order laser light and the interference pattern is recorded by the H2.

The finished H2 is then used to manufacture the H3 HOEs 3 used in displays. The H2 is placed nearly in contact with the unexposed sensitive layer of the H3 holographic plate, a uniform gap is left, which has an optical thickness which is approximately equal to the optical distance between the sensitive layer of the HOE 3 and the liquid crystal cells within the LCD in a finished display, the gap is typically around 1 mm and can be filled with an index matching fluid and/or a thin glass cover sheet bonded to the H2. This sandwich is then exposed using laser light beam(s) which are the conjugate of the reference beam(s) used to make the H2, this light therefore resembles or is identical to the light used in the reference beam(s) used to record the H1.

In use the H3 is reconstructed with the conjugate of the light used to make it, it therefore produces the real images that form the various viewing zones disclosed herein. It also reconstructs an image of the H2 sensitive layer within the LCD, this ensures that the light that is intended to pass through a particular pixel row passes through that row only.

The above describes optical replication procedures, there are other alternative such as replication by moulding relief structure. There are also methods of producing the H1 by calculation and machine writing the HOE to produce the same or equivalent optical performance.

Light sources

For convenience of description the light sources have been represented as discrete objects. The important thing is that the effective location of light sources can be controlled, so multiple discrete light sources might be replaced by fewer sources where the effective position of the sources is changed by optical, opto-electronic or mechanical means.

Light emitting diodes are a good choice of light source. The narrow spectral bandwidth. small size and ease of switching make them ideal.

Viewer detection means and parallax

Most of the above-described embodiments of the present invention rely for their operation on the display being capable of directing light to a number of different viewers. In stereoscopic operation each viewer must see two images—the left image must be seen only by the left eye and the right one by the right eye.

In the holographic implementation the location of the stereo viewing zones 10 depends on the location of the light sources 1 used to illuminate the HOE.

The display can be designed so as to produce a set of fixed viewing positions and in this case the viewers have to find the correct viewing position for themselves, which may or may not be a problem. If the display is required to adjust itself to the viewers and track them if they move, then the light sources 1 will need to be controlled in such a way as to ensure that the correct light source is used for each viewer according to their position (which will change as they move). In order for this to be effected the display (or associated equipment) has to include a means to detect the location of each viewer, and this information is then used to select the appropriate location of the light source(s) used to render the correct picture(s) visible for that viewer.

The location of each viewer can also be used to control the perspective of the picture delivered to each of them. This can be used to display full parallax for each viewer in such a way as to ensure that each viewer see the correct perspective for their position and enjoy parallax in the x, y and z directions that is consistent with their own movements (and independent of the movements of other viewers).

It will be important to avoid intrusive viewer-tracking means so a form of video camera based tracking will probably be best suited to this application. There exist a number of software-based methods to detect and measure the x, y, z location of eyes within a suitable field of view.

In the case of glasses based stereo where spatio-temporal multiplexing is used it is not necessary for the display to adjust to the viewers' position but parallax can be updated for each viewer in the same way as described above. In this case there is a greater choice of means to track the glasses (instead of the viewers' eyes).

Reversion mode when there are too many viewers or when there is no parallax information.

All the embodiments described herein will limited to a certain maximum number of viewers, so it is possible that occasionally more that the maximum number of viewers will wish to watch the display. One solution to this problem would be to provide, say, a four-viewer full parallax display where one or more of the individual-viewer full parallax channels reverts to a multiple-viewer fixed parallax mode. It will be remembered that both the simple spatially and temporally multiplexed approaches can provided as many viewing positions as needed provided the same images are presented to all the positions. Thus the default can easily be implemented by displaying fixed parallax 3D to more than one viewer. Other channels might be left operating with parallax but equally all might default to the fixed parallax mode.

This would also be the default mode if the stereoscopic content had a predetermined and unchangeable viewing position (such as an old 3D movie) rather than content in a form that allows continual updating of perspective according to the viewer's viewing position.

Views onto different scenes—as opposed to different views on the same scene

In much of this document it has been assumed that (a) all viewers should be presented with their own full parallax 3D view and (b) these views are of the same scene. The present invention is not limited to this use. An alternative use is to display quite different pictures to each viewer. A two-viewer combat computer game is an example. If two people are playing against each other each can be provided with their own view—e.g. looking in opposite directions—perhaps towards each other in the virtual world. Furthermore, the two views do not need to be stereoscopic. So this invention is not confined to stereoscopic 3D display applications.

We have shown that varieties of filtering—by Bragg angle or polarisation—can be used to differentiate different spatially multiplexed images. Other filtering methods could also be used—such as narrow bandwidth colour filtering.

1. An autostereoscopic display device capable of displaying different images to multiple viewers, said display device comprising:
a pixel array, such as an LCD array, wherein a first set of pixels within the pixel array cooperates to display a first image and a second, different set of pixels within the pixel array cooperate to display a second image;
a light source array, such as an LED array, comprising a plurality of light sources, each adapted to individually illuminate the pixel array in use;
a holographic optical element (HOE), spatially multiplexed to cooperate with said pixel array such that light from a first light source from within the light source array impinging on the first set of pixels is diffracted by the HOE towards a first position to form a first real image for the left eye of a first viewer and light from the first light source impinging on the second, different set of pixels is diffracted towards a second position to form a second real image for the right eye of said first viewer, whereby the first and second real images together form a first viewing zone;
wherein the HOE diffracts light from different light sources within the light source array towards corresponding spatially displaced viewing zones;
and further comprising control apparatus adapted to cause the first and second sets of pixels to display successively selected pairs of first and second images and to cause the light sources within the light source array to be successively activated in synchronisation with the successively selected image pairs such that light from only one light source within the light source array is incident on the HOE at any one time thereby providing multiple viewing zones for multiple viewers successively and in spatially displaced positions.

2. The autostereoscopic display device of claim 1, wherein the first image is the left image of a stereoscopic pair and the second images is the right image of a stereoscopic pair.

3. The autostereoscopic display device of claim 1, wherein the first and second real images about one another.

4. The autostereoscopic display device of claim 1, wherein the first and second images are the same image.

5. An autostereoscopic display device capable of displaying different images to multiple viewers, said display device comprising;
a pixel array, wherein
a first set of pixels within the pixel array cooperates to display a first image,
a second, different set of pixels within the pixel array cooperate to display a second image,
a third, different set of pixels within the pixel array cooperates to display a third image,
a fourth, different set of pixels within the pixel array cooperate to display a fourth image;
a plurality of light source arrays, each light source array comprising a plurality of light sources, each of the light sources being adapted to individually illuminate the pixel array;
a holographic optical element (HOE), spatially multiplexed to cooperate with said pixel array such that light from a first light source from within a first light source array impinging on the first set of pixels is diffracted by the HOE towards a first position to form a first real image for the left eye of a first viewer, and light impinging on the second, different set of pixels is diffracted towards a second position to form a second real image for the right eye of said first viewer, whereby the first and second real images together form a first viewing zone;
and whereby light from a first light source from within a second light source array impinging on the third set of pixels is diffracted by the HOE towards a third position to form a third real image for the left eye of a second viewer, and light impinging on the fourth, different set of pixels is diffracted towards a fourth position to form a fourth real image for the right eye of said second viewer, whereby the third and fourth real images together form a second viewing zone;
wherein the HOE or a filter element is adapted to prevent light from the first light source array from being diffracted towards the second viewing zone and likewise to prevent light from the second light source array from being diffracted towards the first viewing zone;
and further wherein the HOE diffracts light from different light sources within each light source array to form the respective viewing zones in corresponding spatially displaced positions.

6. The autostereoscopic display device of claim 5, further comprising control apparatus adapted to cause the first and second sets of pixels to display successively selected pairs of first and second images and to cause the light sources within the first light source array to be successively activated in synchronisation with the successively selected pairs of first and second images such that light from only one light source within the first light source array is incident on the HOE at any one time; and further to cause the third and fourth sets of pixels to display successively selected pairs of third and fourth images and to cause the light sources within the second light source array to be successively activated in synchronisation with the successively selected pairs of third and fourth images such that light from only one light source within the second light source array is incident on the HOE at any one time.

7. The autostereoscopic display device of claim 5 wherein the spatially multiplexed HOE is adapted such that a first set of regions of the HOE is in the spatially multiplexed configuration corresponding to the first and second sets of pixels of the pixel array diffracts light to form the first viewing zone only when illuminated by light impinging on it from one range of angles, and a second set of regions of the HOE corresponding to the third and fourth sets of pixels within the pixel array diffracts light to form the second viewing zone only when illuminated by light impinging on it from a substantially different range of angels.

8-19. (canceled)

20. A multi-view autostereoscopic display comprising:
a pixel array, such as an LCD array, providing a plurality of sets of pixels, the first set of pixels being adapted to display a first image and a third image, sequentially, and the second set of pixels being adapted to display a second and fourth image, sequentially;
first and second light sources, such as LEDs, each of the light sources being adapted to individually illuminate the pixel array;
a HOE spatially multiplexed to cooperate with said pixel array such that light from the first light source impinging on a first set of pixels is diffracted by the HOE towards a first position to form a first real image for a viewer, and light from the first light source impinging on a second, different set of pixels is directed towards a second position spatially displaced from the first to form a second real image for the viewer, and further wherein the spatial multiplexing of the HOE is adapted such that light from the second light source impinging on the first set of pixels is diffracted by the HOE towards a third position to form a third real image for the viewer, and light from the second light source impinging on the second, different set of pixels is directed towards a fourth position, spatially displaced from the third to form a fourth real image for the viewer, said first and second real images being spatially displaced from the third and fourth real images; and
control apparatus adapted to cause the first set of pixels to sequentially display the first and third images in synchronisation with sequential activation of the first and second light sources, and to cause the second set of pixels to sequentially display the second and fourth images in synchronisation with sequential activation of the first and second light sources.

21. The multi-view autostereoscopic display of claim 20, wherein the first and third real images abut one another, and are formed adjacent to or overlapping with the second and fourth real images, wherein said second and fourth real images abut one another.

22. The multi-view autostereoscopic display of claim 20, wherein the first and third real images are interleaved with the second and fourth real images.

23. The multi-view autostereoscopic display of claim 20, wherein each image is a different perspective view of an object.

24. The multi-view autostereoscopic display of claim 20, wherein adjacent real images form a stereo pair.

25. The multi-view autostereoscopic display of claim 20, further comprising additional light sources and additional corresponding sets of pixels adapted to provide further real images spatially displaced from the first to fourth images.

26. The display device according to claim 20, wherein the real images forming a viewing zone are homogenous and diffuse.

27-28. (canceled)

29. The display device according to claim 1, wherein the control apparatus is adapted to refresh the image(s) displayed by the set(s) of pixels at a refresh rate fast enough, such as at least about 60 Hz, for a substantially flicker-free image to be seen by the viewer(s).

30. (canceled)

31. A display device according to claim 1, wherein the HOE is upstream of the pixel array with respect to the light source array(s).

32-34. (canceled)

35. A display device according to claim 1, wherein the display device provides different images for all or some of the viewers of the display.

36. (canceled)

37. A display device according to claim 1, wherein the display device provides different stereoscopic images for some or all of the viewers of the display.

38. A display device according to claim 1, wherein the display device is equipped with a viewer detection means to detect the location of one or more viewers.

39. A display device according to claim 1, wherein the display device is arranged to deliver images with different perspective to all or some of the viewers.

40. (canceled)
